(19) United States
(12) Patent Application Publication
(10) Pub. No.: US 2021/0073257 A1
(43) Pub. Date: Mar. 11, 2021

(54) LOGICAL DOCUMENT STRUCTURE IDENTIFICATION

(71) Applicant: Syntexys Inc., Palo Alto, CA (US)

(72) Inventor: Neville Newey, Pleasanton, CA (US)

(21) Appl. No.: 17/013,262

(22) Filed: Sep. 4, 2020

Related U.S. Application Data
(60) Provisional application No. 62/897,536, filed on Sep. 9, 2019.

(51) Int. Cl. G06F 16/35; G06N 20/00

(52) U.S. Cl. CPC G06F 16/355; G06N 20/00

(57) ABSTRACT

To support the task of analyzing unstructured text, computer-implemented statistical natural language processing-based techniques for automatically identifying the unstructured text's logical structure are disclosed. The techniques can be used to automatically covert unstructured text into structured text. In a possible implementation of the present invention, the structured text is well-formed and schema-validated eXtensible Markup Language (XML) formatted text. Instead of relying solely on rules to convert unstructured text to structured text, disclosed techniques use statistical natural language processing techniques to recognize section boundaries in unstructured text.

### CROSS-REFERENCE TO RELATED APPLICATION; BENEFIT CLAIM

This application claims the benefit of U.S. provisional patent application No. 62/897,536, filed Sep. 9, 2019, the entire contents of which is hereby incorporated by reference as if fully set forth herein, under 35 U.S.C. § 119(e).

### TECHNICAL FIELD

The present disclosure generally relates to computer-implemented techniques for identifying the logical structure of an electronic document containing unstructured text.

### BACKGROUND

The decreasing cost of mass data storage devices and the increasing prevalence of network-based data storage services has enabled businesses and organizations to store more and more electronic documents containing unstructured text. These stored documents can include, for example, digital copies of executed legal contracts that represent contractual obligations of a business or organization and other types of authored text documents.

Often, there is a need to periodically analyze the stored electronic documents. The analysis may be conducted for various reasons. For example, a company may wish to review the liquidated damages clauses of a set of pending contracts to determine its total monetary liability in the event of breach. As another example, a company may wish to review the conditions on which certain contracts can be terminated. These are just two examples of electronic document analysis that may be conducted, and various different types of analyses may be performed to meet a particular need at hand.

Conventionally, electronic document analysis is conducted manually by humans. This manual process typically involves a human using a computer with a display screen to visually scan electronic documents to identify a section of interest (e.g., the liquidated damages clause) and then reading the section of interest for understanding. Manually scanning electronic documents for relevant sections can be time consuming and labor intensive.

Computer-based tools exist to aid in the identification of relevant electronic document sections. For example, computer applications exist for viewing electronic documents on a computer display screen. Such applications often provide a keyword search feature that allows the user to enter a keyword identifying a section of interest. Upon entering the keyword, the application identifies a portion of the electronic document containing a keyword that matches the entered keyword and presents the portion of the electronic document to the user on the computer display screen.

More automated solutions for identifying relevant electronic document sections exist. Nonetheless, a bottleneck in the computerized analysis of electronic documents remains in the identification, understanding, and processing of pertinent electronic document sections. Humans are still largely confined to manually scanning, reading, and annotating electronic documents.

Embodiments of the present invention addresses this and other needs.

The approaches described in this section are approaches that could be pursued, but not necessarily approaches that have been previously conceived or pursued. Therefore, unless otherwise indicated, it should not be assumed that any of the approaches described in this section qualify as prior art, or are well understood, routine, or conventional, merely by virtue of their inclusion in this section

### BRIEF DESCRIPTION OF THE DRAWINGS

In the drawings:

FIG. 1 schematically depicts an example logical document structure identification computing system, according to a possible implementation of the present invention.

FIG. 2 is a flowchart of example processing operations performed by an inside-outside-beginning tag generator, according to a possible implementation of the present invention.

FIG. 3 is a flowchart of example processing operations performed by a sequence labeling model trainer to learn a sequence labeling model from inside-outside-beginning tags generated by an inside-outside-beginning tag generator, according to a possible implementation of the present invention.

FIG. 4 is a flowchart of example processing operations performed by an auto-tagger to predict text of an unstructured text document that belongs to a heading using a sequence labeling model, according to a possible implementation of the present invention.

FIG. 5 is a flowchart of example processing operations performed by an auto-tagger to identify the boundaries of sections in an unstructured text document, according to a possible implementation of the present invention.

FIG. 6 is a flowchart of example processing operations performed by an auto-tagger to determine the hierarchical relationships between identified sections in an unstructured text document, according to a possible implementation of the present invention.

FIG. 7 is a block diagram of a computer system that may be used in a computing system implementation of the present invention.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, some structures and devices are shown in block diagram form in order to avoid unnecessarily obscuring the present invention.

### General Overview

Using a computer to automatically detect sections in unstructured text is a difficult task. This is due to the nature of unstructured text. Most unstructured text is authored by humans. Humans have different writing styles and express sections in different, often difficult to predict ways. Writing styles may be mixed within the same document. There is no standard definition of what a section is. There are no standard set of rules for determining where a section starts and where it ends. For example, what does a change in heading numbering style from “I.” to “(a)” mean? Sections at the same indentation level in the same document can be at different levels in the document's logical structure. Boundaries of sections and the hierarchical relationships between sections may be apparent to a human reader, but difficult for a computer to reliably determine. As a result, it has historically been a challenging task to design a computing machine that can reliably and automatically detect sections and hierarchical relationships therebetween in unstructured text.

Embodiments of the present invention addresses these and other issues.

To support the task of analyzing unstructured text, computer-implemented statistical natural language processing-based techniques for automatically identifying the unstructured text's logical structure are disclosed. The techniques can be used to automatically convert unstructured text into structured text. In a possible implementation of the present invention, the structured text is well-formed and schema-validated eXtensible Markup Language (XML) formatted text. However, other structured text formats are possible as described in greater detail below.

Instead of relying solely on rules to convert unstructured text to structured text, disclosed techniques use statistical natural language processing techniques to recognize section boundaries in unstructured text. A section boundary may be defined as an imaginary character that occurs in unstructured text precisely before the first actual text character in a section and immediately after the last actual text character in the previous section. This imaginary start of section character is referred to herein as a “section boundary character.” In addition, there can be a section boundary character before the first actual text character in an unstructured text document and immediately after the last actual text character in the unstructured text document. All sections in the unstructured text document can thus occur exactly between two consecutive section boundary characters.

As used herein, the term “text” encompasses a sequence of text characters belonging to a source coded computer character set. For example, text can be a sequence of ASCII, ISO/IEC 10646, or UNICODE characters. The characters of text can be encoded using a computer character encoding scheme such as, for example, UTF-8, UTF-16, UTF-32, or the like. As used herein, the term “document” encompasses text where the sequence of encoded text characters of the text has a determinable beginning and end.

As used herein, the term “unstructured text” encompasses text that is in a different format than a structured text representation of the unstructured text generated from the unstructured text according to an implementation of the present invention. As one skilled in the art will understand from this disclosure, unstructured text that is automatically converted to a structured text representation according to an implementation of the present invention may, in different contexts outside the context of the implementation of the present invention, be considered unstructured text, semi-structured text, or structured text.

In a possible implementation of the present invention, section boundary characters and sections have the following properties:
A section boundary character never occurs inside a section.
A section boundary character always occurs directly before the first actual text character in a section and directly after the last actual text character in a section.
Each actual text character in a document—excluding section boundary characters—always occurs between two consecutive section boundary characters.
Each section boundary character, except for the first section boundary character of a document and the last section boundary character of a document, serve as both the beginning of the next section and the end of the previous section.
Every section of a document is bounded by precisely two section boundary characters.

Sections identified in a document can have hierarchical relationships with one another. For example, a particular section A can be a sub-section of another section B which itself can be a sub-section of yet another section C. In this example, it can be said that section A is a “parent” of section B which is a “parent” of section C. Other hierarchical relationships between sections of a document are possible including child, grandchild, grandparent, sibling, descendant, and ancestor relationships.

Computer-implemented techniques are disclosed herein for automatically identifying the hierarchical relationships between sections in a document. The identified hierarchical relationships are then captured in the structured text output. The disclosed techniques for automatically identifying the hierarchical relationships between sections in a document can be used in conjunction with or independent of the disclosed statistical natural language processing-based techniques for recognizing section boundaries in unstructured text.

The disclosed techniques can provide a number of technological improvements over existing approaches for logical document structure identification. Compared to a solely rule-based approach for identifying sections, the statistical natural language processing-based techniques disclosed herein can be more robust and more flexible. For example, the disclosed approach can identify new sections without having to program new rules in order for a computer to make the identification. The disclosed techniques can also provide automatic structured encoding of unstructured text. For example, the disclosed techniques might be used in a possible implementation to automatically covert an unstructured text document uploaded by a user of an online service to a structured text representation that identifies sections in the uploaded unstructured text and hierarchical relationships therebetween in a structured text format that is both human and machine-readable.

The disclosed techniques have a wide-variety of practical applications. In general, the disclosed techniques can be useful to improve any technical computing field where there is a need to convert unstructured text into structured text. Some non-limiting examples of possible technical computing fields that the disclosed techniques can improve include converting different unstructured text documents into a common structured text format, legal contract analytics, legislative analysis, document comparison, research on large document corpora (e.g., academic research papers), semantic analysis, standardized document formatting, section level indexing and searching, detecting document author errors (e.g., missing definitions), correcting document author errors (e.g., fixing inconsistent section numbering), and document style detection.

The present invention will now be described in greater detail with reference to the figures.

### Logical Document Structure Identification System

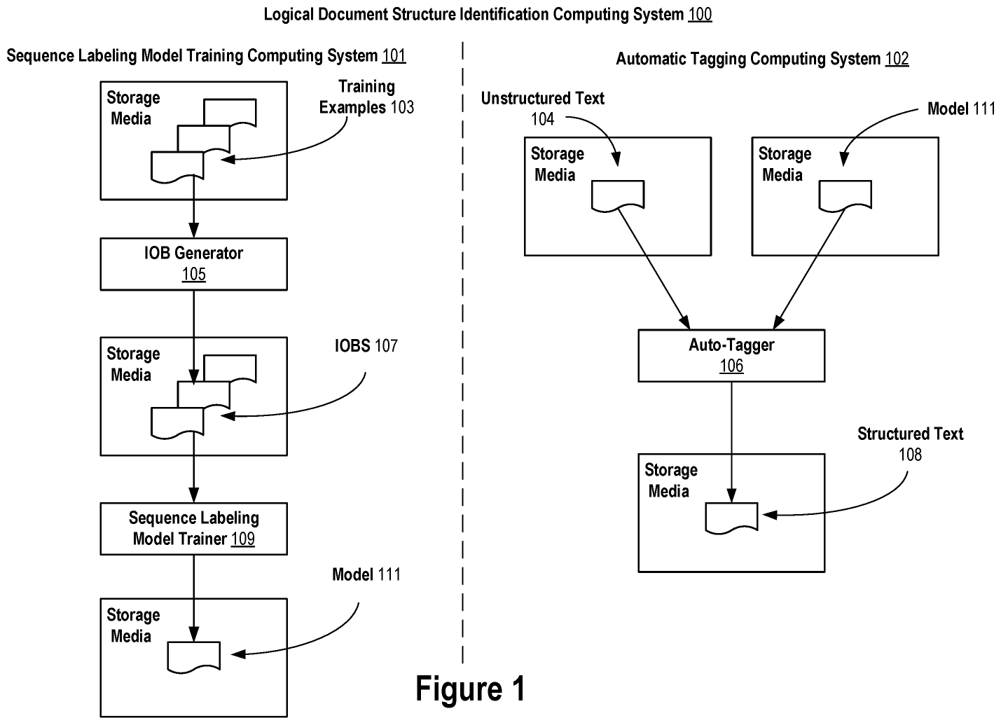

FIG. 1 schematically depicts logical document structure identification computing system 100 according to a possible implementation of the present invention. System 100 encompasses sequence labeling model training computing system 101 (hereinafter referred to as “training system 101”) and automatic tagging computing system 102 (hereinafter referred to as “auto-tagger system 102”).

Training system 101 includes storage media storing training examples 103 that are input to inside-outside-beginning tag (JOB) generator 105 which processes training examples 103 and outputs IOBs 107 to storage media. IOBs 107 are input to sequence labeling model trainer 109 which processes IOBs 107 and outputs sequence labeling model 111 to storage media.

Auto-tagger system 102 includes storage media storing unstructured text document 104. Auto-tagger system 102 also includes storage media storing model 111 output by model trainer 109. Unstructured text document 104 and model 111 are input to auto-tagger 106 which processes unstructured text document 104 using model 111 and outputs structured text document 108 to storage media.

IOB generator 105, model trainer 109, and auto-tagger 106 can execute as one or more processes on one or more computer systems to perform corresponding processing operations. While each can execute as separate processes, two or all three can execute as the same process. Such a process can execute one or more sets of computer-programmed instructions (i.e., one or more computer programs) configured to carry out the processing operations disclosed herein ascribed to IOB generator 105, model trainer 109, and/or auto-tagger 106. The one or more sets of computer-programmed instructions can be stored in one or more storage media, both when being executed as one or more processes and when not being executed.

Example processing operations performed by IOB generator 105, model trainer 109, and auto-tagger 106 are described in greater detail herein.

The storage media can encompass non-volatile media and/or volatile media. Non-volatile media includes, for example, read-only memory (e.g., EEPROM), flash memory (e.g., solid-state drives), magnetic storage devices (e.g., hard disk drives), and optical discs (e.g., CD-ROM). Volatile media includes, for example, random-access memory devices, dynamic random-access memory devices (e.g., DRAM) and static random-access memory devices (e.g., SRAM).

Although depicted in FIG. 1 as separate storage media, some or all of the various storage media depicted in FIG. 1 can actually be the same storage media. For example, some or all of training examples 103, IOBs 107, model 111, unstructured text document 104, and structured text document 108 can be stored on the same, common, or shared storage media. Nonetheless, separate storage media can be used. For example, the storage media storing model 111 input to auto-tagger 106 may be different storage media than the storage media to which trainer 109 outputs model 111. For example, model 111 can be copied as a file between different storage media.

### Headings

An unstructured text document often has authored headings. To a human reading the unstructured text document, the headings serve as a cue to the reader that a previous section has ended and a new section is about to start. The headings also often indicate the subject matter of the new section.

For example, consider the following unstructured text with headings containing clauses of a legal contract:
(e) Payment of Stamp Tax. Subject to Section 11, it will pay any Stamp Tax levied or imposed upon it or in respect of its execution or performance of this Agreement by a jurisdiction in which it is incorporated, organised, managed and controlled, or considered to have its seat, or in which a branch or office through which it is acting for the purpose of this Agreement is located (“Stamp Tax Jurisdiction”) and will indemnify the other party against any Stamp Tax levied or imposed upon the other party or in respect of the other party's execution or performance of this Agreement by any such Stamp Tax Jurisdiction which is not also a Stamp Tax Jurisdiction with respect to the other party.
5. Events of Default and Termination Events
(a) Events of Default. The occurrence at any time with respect to a party or, if applicable, any Credit Support Provider of such party or any Specified Entity of such party of any of the following events constitutes an event of default (an “Event of Default”) with respect to such party:

In the above example unstructured text document, a human reader might identify the following three different headings:
1. “(e) Payment of Stamp Tax.”
2. “5. Events of Default and Termination Events”
3. “(a) Events of Default.”

As discussed above, while it may be intuitive for a human to identify the text in an unstructured text document that is part of a heading, is not straightforward to program a computer to do so. Conventional rule-based approaches such as those that rely solely on regular expression matching can be too fragile and too inflexible for general use. The present invention eschews a solely rule-based approach with an approach that uses statistical natural language processing techniques.

Training examples 103 are for use by model trainer 109 to learn model 111 from training examples 103. Training examples 103 can contain unstructured text examples of headings. The heading examples can be converted to IOBs 107 (e.g., encompassing a collection of one or more text documents) by IOB generator 105. Model trainer 109 can learn model 111 based on IOBs 107. Training examples 103 can encompass a collection of one or more text documents. IOBs 107 can also encompass a collection of one or more text documents. Model 111 can encompass a collection of one or more files containing learned model data (e.g., model parameters).

Model 111 can then be used by auto-tagger 106 to predict the text in unstructured text document 104 that is part of a heading. Based on the heading predictions, auto-tagger 106 can determine section boundaries of sections in unstructured text document 104. Structured text document 108 output by auto-tagger 106 can identify the text of unstructured text document 104 that belongs to each predicted heading and can identify the text of unstructured text document 104 that belongs to each identified section. In addition, auto-tagger 106 can arrange the identification of the sections in structured text document 108 such that the arrangement represents the hierarchical relationships between the identified sections.

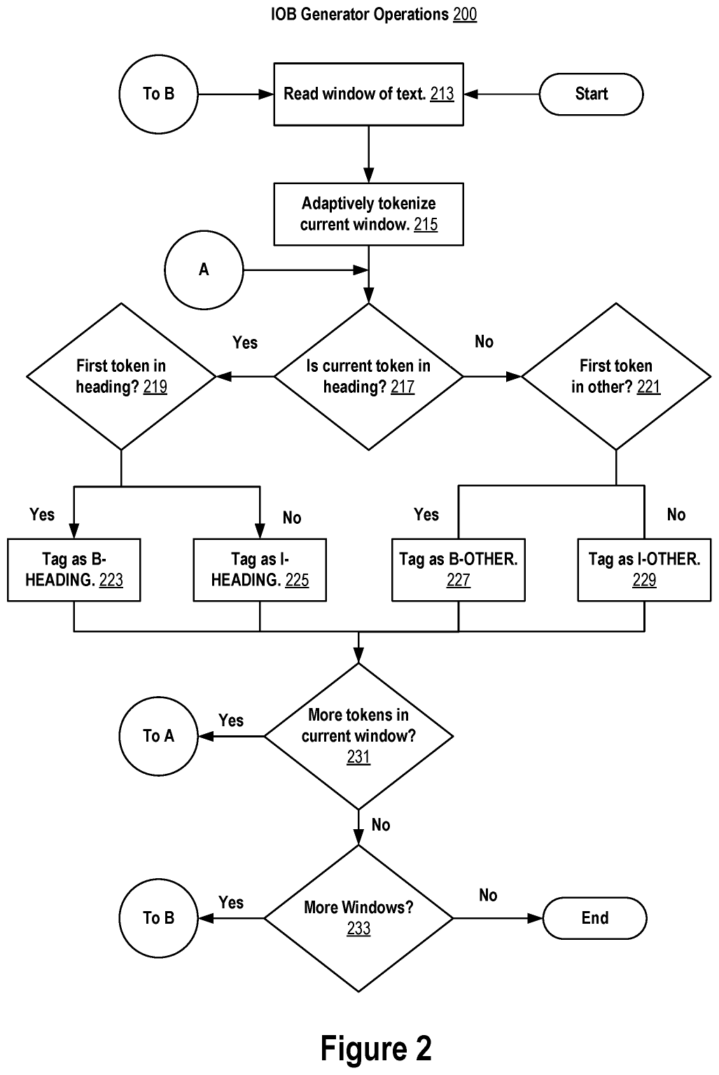

Example processing operations performed by IOB generator 105 to convert heading examples in training examples 103 to IOBs 107 are described below with respect to the flowchart of FIG. 2.

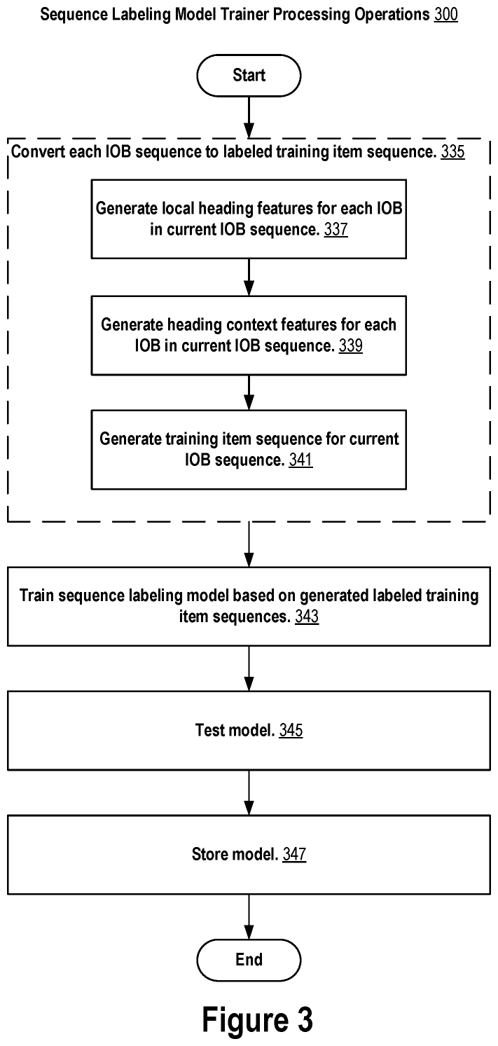

Example processing operations performed by model trainer 109 to learn model 111 from IOBs 107 are described below with respect to the flowchart of FIG. 3.

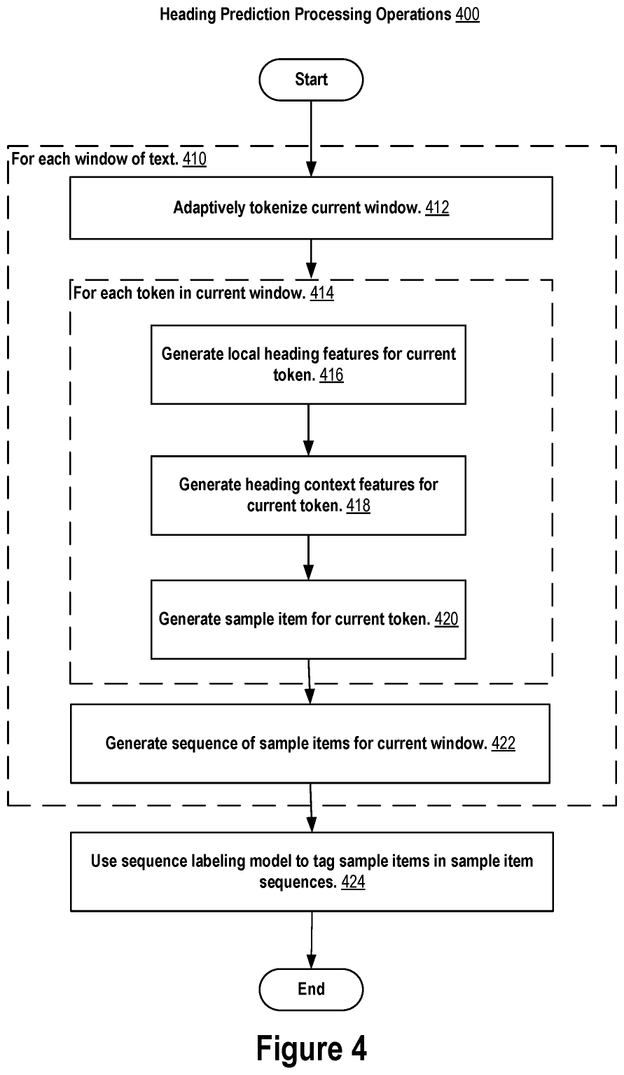

Example processing operations performed by auto-tagger 106 to predict the text of unstructured text document 104 that belongs to headings are described below with respect to the flowchart of FIG. 4.

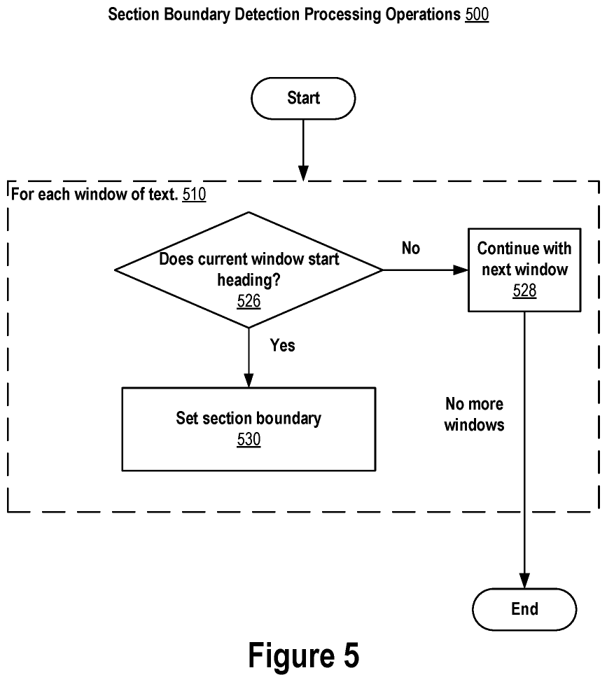

Example processing operations performed by auto-tagger 106 to identify the section boundaries in unstructured text document 104 are described below with respect to the flowchart of FIG. 5.

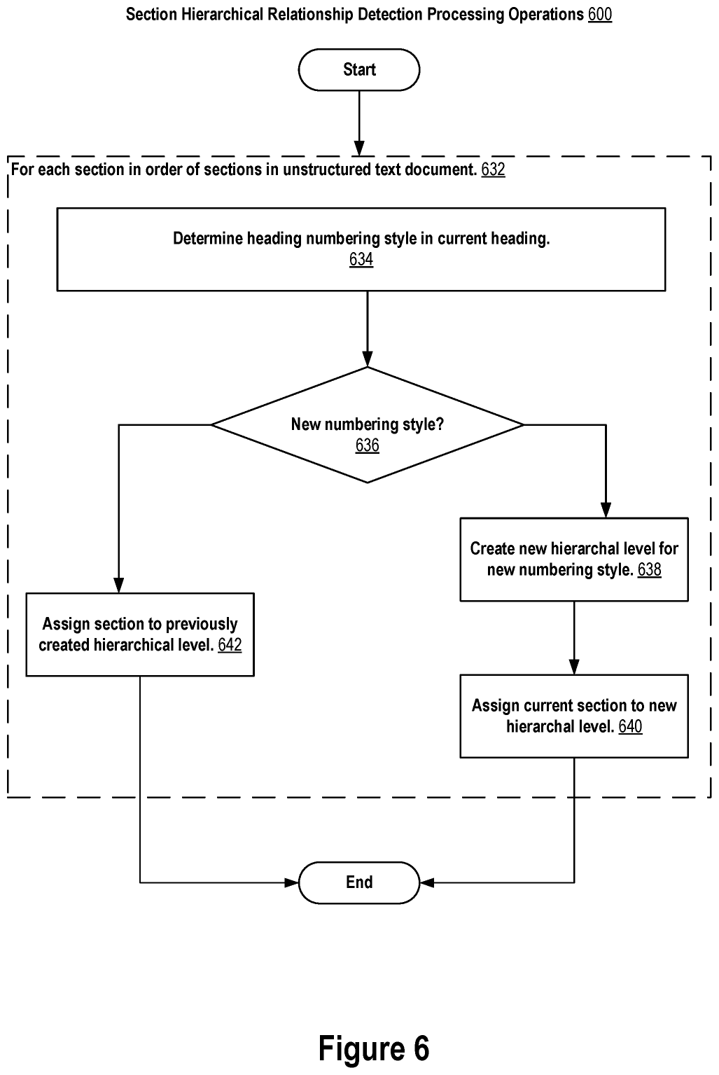

Example processing operations performed by auto-tagger 106 to determine the hierarchical relationships between identified sections in unstructured text document 104 are described below with respect to the flowchart of FIG. 6.

### IOB Generator

FIG. 2 is a flowchart of example processing operations 200 performed by IOB generator 105, according to a possible implementation of the present invention. A purpose of IOB generator 105 performing operations 200 can be to convert heading training examples 103 into IOBs 107 that is more suitable for use by model trainer 109 for learning sequence labeling model 111. As described in greater detail below, IOBs 107 can encompass sequences of IOB tagged tokens according to a heading IOB format.

In computational linguistics generally, inside-outside-beginning (JOB) tagging format is a tagging format for tagging tokens in a text chunking task. An IOB tag of a token can have a “B-” prefix or an “I-” prefix followed by a tag name. The “B-” prefix before a tag name indicates that the tagged token is the beginning of a chunk. The “I-” prefix before a tag name indicates that the tagged token is inside a chunk. An “O” IOB tag indicates that the tagged token does not belong to a chunk. More information on the IOB tagging format can be found in the paper by Ramshaw and Marcus (1995), “Text Chunking using Transformation-Based Learning,” arXiv:cmp-lg/9505040, the entire contents of which is hereby incorporated by reference.

Operations 200 adapt the IOB tagging format specifically for use by model trainer 109 to learn model 111 so that model 111 when used by auto-tagger 106 is capable of differentiating between text sequences of unstructured text document 104 that belong to a heading and other text sequences of unstructured text document 104 that do not belong to a heading.

IOBs 107 generated by IOB generator 105 adhere to a heading IOB format. As described in greater detail below, an even more specific IOB tagging format is applied by model trainer 109 to IOBs 107 before learning model 111 based on the more specific IOB tagging format applied to IOBs 107.

A heading IOB format can include the following IOB tags, or their representational equivalents:
B-HEADING
I-HEADING
B-OTHER
I-OTHER

The “B-HEADING” IOB tag can be used to tag a token that is the beginning of a heading. The “I-HEADING” IOB tag can be used to tag a token that is inside a heading. The “B-OTHER” IOB tag can be used to tag a token that is the beginning of other type of text (e.g., non-heading text). The “I-OTHER” IOB tag can be used to tag a token that is inside other text.

A heading can be text of unstructured text that includes a title or label at the beginning or head of a section of the unstructured text. Other text is all other text of unstructured text that is not a heading. Other text can start at the beginning of an unstructured text document or after a heading in unstructured text. Thus, all text of unstructured text can be classified as either a heading or other text.

Operations 200 apply a heading IOB format to training examples 103. Training examples 103 can contain unstructured text and heading identification data. The heading identification data can identify the text of the unstructured text that are headings. In a possible implementation of the present invention, headings are identified in unstructured text of training examples 103 using XML-like markup. For example, a heading in the unstructured text of training examples 103 can be surrounded with a <HEADING>{text}</HEADING> tag pair to designate the text enclosed by the tag pair as a heading. Here, the tag name “HEADING” is not required and other tag names can be used. For example, the tag name could just as easily by “H”, “HEAD”, “heading”, “Heading,” or other suitable tag name.

Returning to a prior example, <HEADING> . . . </HEADING> tag pairs are used to markup text of the following unstructured text that are headings. Text of the unstructured text that is not enclosed in the <HEADING> . . . </HEADING> tag pairs can be considered other text.
<HEADING>(e) Payment of Stamp Tax.</HEADING> Subject to Section 11, it will pay any Stamp Tax levied or imposed upon it or in respect of its execution or performance of this Agreement by a jurisdiction in which it is incorporated, organised, managed and controlled, or considered to have its seat, or in which a branch or office through which it is acting for the purpose of this Agreement is located (“Stamp Tax Jurisdiction”) and will indemnify the other party against any Stamp Tax levied or imposed upon the other party or in respect of the other party's execution or performance of this Agreement by any such Stamp Tax Jurisdiction which is not also a Stamp Tax Jurisdiction with respect to the other party.
<HEADING>5. Events of Default and Termination Events</HEADING>
<HEADING>(a) Events of Default.</HEADING> The occurrence at any time with respect to a party or, if applicable, any Credit Support Provider of such party or any Specified Entity of such party of any of the following events constitutes an event of default (an “Event of Default”) with respect to such party:

While in the above-example, the heading identification data includes XML-like tag pairs that are used to markup unstructured text to specify headings in the unstructured text, the heading identification data can take other data forms including virtually any data form suitable for identifying sequences of text characters in unstructured text that are headings. For example, the heading identification data can be stored separately from the unstructured text (e.g., in a different file) and can point to the headings in the unstructured text with byte or character offsets. As another alternative, training examples 103 can be formatted in a known data serialization format that contains the unstructured text and the heading identification data according to the data serialization format used. Some possible known data serialization formats that could be used include eXtensible Markup Language (XML), JavaScript Object Notation (JSON), YAML, or the like.

Summarizing process 200, it starts by reading 213 a window of text from training examples 101. The window of text is adaptively tokenized 215. As used herein, a “token” encompasses a sequence of one or more text characters of unstructured text. For each token in the current window, if the current token is in a heading 217 and the current token is the first token in the heading 219, then the current token is IOB tagged as “B-HEADING” 223. If the current token is in a heading 217 but the current token is not the first token in the heading 219, then the current token is IOB tagged as “I-HEADING” 225. If the current token is not in a heading 217 and the current token is the first token in other text, then the current token is IOB tagged as “B-OTHER” 227. If the current token is not in a heading 217 and the current token is not the first token in other text, then the current token is IOB tagged as “I-OTHER” 229. Process 200 returns to operation 217 for the next token in the current window if there is one 231. If there are no more tokens in the current window 231, then process 200 returns to operation 213 to read the next window of text from training examples 233. Process 200 ends after all windows of text in training examples 103 have been processed 233. As a result of performing operations of process 200, tokens of training examples 103 are each IOB tagged as either beginning a heading, inside a heading, beginning other text, or inside other text.

Returning to the top of process 200, a window of consecutive text characters is read 213 from training examples 103. The window can be a line of text or a grammatical unit of text (e.g., a sentence, a clause, or paragraph) or a predefined number of text characters. (e.g., 20, 40, 60, or 80 text characters). No particular size or length of a window is required. Further, not all windows read 213 from training examples 101 need be the same size or length, or use the same criteria that determines the size or length of a window read 213.

At operation 215, the current window of text is adaptively tokenized. By adaptively tokenized, it is meant that some tokens of the current window can be single text character tokens and some tokens of the current window can be multi-character tokens. In a possible implementation, numbers and words are tokenized from the current window differently from other text characters of the current window. In particular, a number or a word can be tokenized as a multi-character token while other text characters including punctuation and whitespace can be tokenized as single-character tokens. By doing so, model trainer 109 can better train model 111 to predict headings in unstructured text as headings often comingle punctuation and whitespace with numbers and words.

A number may be defined as a sequence of consecutive numerical or ordinal text characters in unstructured text. As well as numerical digits, numbers can include other ordinals such as roman numerals and outline heading numbering (e.g., “I”, “II”, “III”, etc; “A”, “B”, “C”, etc.; “i”, ii”, “iii”, etc.). A word may be defined as a sequence of consecutive alphabetic or letter text characters in unstructured text including alphabetic or letter text characters with diacritics. Punctation and whitespace can include all of the following text characters that are not numbers or words, or a subset of these text characters, or a superset of the subset:

| Text Character | |
|---|---|
| (Unicode Hex) | Description |
| 0x005B | Left Square Bracket |
| 0x005D | Right Square Bracket |
| 0x0025 | Percent Sign |
| 0x0022 | Quotation Mark |
| 0x0028 | Left Parenthesis |
| 0x0029 | Right Parenthesis |
| 0x002E | Full Stop |
| 0x002C | Comma |
| 0x003B | Semicolon |
| 0x003A | Colon |
| 0x000A | Newline |
| 0x0009 | Tab |
| 0x0020 | Space |
| 0x00AE | Registered Sign |
| 0x00A9 | Copyright |
| 0x0024 | Dollar sign |
| 0x002B | Plus |
| 0x002A | Asterisk |
| 0x0040 | Commercial At |
| 0x00A7 | Section Sign |
| 0x003D | Equals Sign |

In the above table, punctuation and whitespace characters are represented by their UNICODE character code expressed as a hexadecimal value. The above list of punctuation and whitespace text characters are just some possible text characters that can be considered punctuation and whitespace for purposes of adaptive tokenization 215. More generally, any text characters considered punctuation or whitespace in UNICODE can be considered punctuation and whitespace for purposes of adaptive tokenization 215.

Markup tags inline with unstructured text used to designated headings can be treated specially for purposes of adaptive tokenization 215. In particular, the markup tags can be considered a special sequence of text characters that is not a number token, a word token, a punctuation token, or a whitespace token.

As an example of adaptive tokenization 215, consider the following example window of text read 213 from training examples 103:
<HEADING>(e) Payment of Stamp Tax.</HEADING> Subject to Section 11, it wil

In this example, the window of text stops after the first letter ‘1’ in the word “will.” The second letter ‘1’ in the word “will” may start the next window of text read 213 from training examples 103. Adaptative tokenization operation 215 might identify the following sequence of tokens in the example window:
1. Open parentheses token.
2. Word token “e”.
3. Close parentheses token.
4. Space token.
5. Word token “Payment”.
6. Space token.
7. Word token “of”
8. Space token.
9. Word token “Stamp”
10. Space token.
11. Word token “Tax”.
12. Full stop token.
13. Space token.
14. Word token “Subject”.
15. Space token.
16. Word token “to”.
17. Space token.
18. Word token “Section”.
19. Space token.
20. Number token “11”.
21. Comma token.
22. Space token.
23. Word token “it.”
24. Space token.
25. Word token “wil”.

As can be seen from this example, adaptive tokenization 215 can treat some sequences of text characters in the current window as single-character tokens (e.g., punctuation and whitespace) and other sequences of text characters in the current window as multi-character tokens (e.g., numbers and words).

Operations 217, 219, 221, 223, 225, 227, or 229 can be performed for each token in the current window in the order in which the tokens occur in the current window.

At operation 217, it is determined whether the current token is in a heading. This determination can be based on the heading identification data. For example, if the current token occurs between a <HEADING> . . . </HEADING> tag pair, then it can be determined that the current token is in a heading.

If the current token is in a heading 217, then it is determined if the current token is the first token in the sequence of tokens that make up the heading 219. For example, in the above-example window, the first token in the heading is the open parentheses token. It should be noted that the first token in a heading need not also be the first token in the current window. For example, the window may start with non-heading text. Along the same lines, a window may contain no headings, only one heading, or more than one heading.

If the current token is the first token in a heading 219, then the current token is assigned the IOB tag “B-HEADING” to designate that the current token begins a heading 223. On the other hand, if the current token is not the first token in a heading 219 but is a token in a heading 217, then the current token is assigned the IOB tag “I-HEADING” to designate that the current token is inside a heading but does not begin the heading 225.

If the current token is not in a heading 217, then it is determined if the current token is the first token in a sequence of tokens that make up other text 221. For example, in the above-example window of text, the first token in other text is the space token following the ending </HEADING> tag and immediately preceding the word token “Subject”. It should be noted that the first token in other text can be, but need not be, the first token following a heading. For example, the first token in a text document that is not in a heading (e.g., the first token in the text document) can be the first token in other text.

If the current token is the first token in other text 221, then the current token is assigned the IOB tag “B-OTHER” to designate that the current token begins the other text 227. On the other hand, if the current token is in other text 217 but not the first token in the other text 221, then the current token is assigned the IOB tag “I-OTHER” to designate that the current token is inside other text but does not begin the other text 229.

It should be noted that the first token in a window need not be the first token in a heading or the first token in other text. For example, if a heading or other text spans multiple windows, then the first token of a window can be inside the heading or inside the other text.

While the IOB tag names “HEADING” and “OTHER” can be used, other IOB tag names are possible and can be used instead of those example IOB tag names. In general, any IOB tag name that can distinguish between tokens in a heading and tokens in other text can be used.

At operation 231, if there are more tokens in the sequence of tokens in the current window, then process 200 returns to operation 217 to process the next token in the sequence. On the other hand, if there are no more tokens in the sequence of tokens in the current window 231, then process 200 proceeds to operation 233 that determines whether there are more windows of text to process in training examples 103. For example, training examples 103 can be processed sequentially, one window at a time. If there are more windows to process in training examples 103, then process 200 returns to operation 213 to read and process the next window of text 233. On the other hand, if there are no more more windows of text to process in training examples 103, then process 200 ends 233.

As a result of performing operations 200, sequences of IOB tagged tokens can be obtained. The sequences of IOB tagged tokens can be stored as IOBs 107. The sequences of IOB tagged tokens can corresponds to the sequences of tokens in the windows of text read from training examples 103 and processed by operations 200. Each sequence of IOB tagged tokens can correspond to one window of text process. For example, returning the above-example, the following sequence of IOB tagged tokens can result from performing operations 200 on the text window: “<HEADING>(e) Payment of Stamp Tax.</HEADING> Subject to Section 11, it wil” (surrounding double quotes are not considered part of the text window).

| Token | IOB Tag |
|---|---|
| Open parentheses token. | B-HEADING |
| Word token “e”. | I-HEADING |
| Close parentheses token. | I-HEADING |
| Space token. | I-HEADING |
| Word token “Payment”. | I-HEADING |
| Space token. | I-HEADING |
| Word token “of” | I-HEADING |
| Space token. | I-HEADING |
| Word token “Stamp” | I-HEADING |
| Space token. | I-HEADING |
| Word token “Tax”. | I-HEADING |
| Full stop token. | I-HEADING |
| Space token. | B-OTHER |
| Word token “Subject”. | I-OTHER |
| Space token. | I-OTHER |
| Word token “to”. | I-OTHER |
| Space token. | I-OTHER |
| Word token “Section”. | I-OTHER |
| Space token. | I-OTHER |
| Number token “11”. | I-OTHER |
| Comma token. | I-OTHER |
| Space token. | I-OTHER |
| Word token “it”. | I-OTHER |
| Space token. | I-OTHER |
| Word token “wil”. | I-OTHER |

Thus, in this example window, there is a heading and other text. An open parentheses token begins the heading and a space token begins the other text. The other tokens are either inside the heading or inside the other text.

In this way, windows of text in training examples 103 can be processed and converted to corresponding sequences of IOB tagged tokens which are stored as IOBs 107 in a heading IOB format. In a possible implementation, only windows of text in training examples 103 that contain at least one token belonging to a heading are processed 200 and converted to corresponding sequences of IOB tagged tokens and stored as IOBs 107 in a heading IOB format. In this implementation, each sequence of IOB tagged tokens stored in IOBs 107 contains at least one token that is tagged as either B-HEADING or I-HEADING. However, it is also possible for all tokens in a sequence of IOB tagged tokens to be tagged as either B-HEADING or I-HEADING.

Operations 200 are shown in FIG. 2 and described above are being performed in a particular order. However, one skilled in the art will recognize that modification or rearrangement of operations 200 including the addition of other operations or the removal of some of operations 200 can be applied in an equivalent implementation. For example, it is possible to read all or multiple windows of text from training examples 101 at a time before IOB tagging any tokens in the windows. Likewise, it is possible to tokenize all or multiple windows of text before IOB tagging any tokens in the windows. Thus, FIG. 2 and the accompanying description above is provided for purposes of illustration and not limitation.

### Sequence Labeling Model Trainer

FIG. 3 is a flowchart of example processing operations 300 performed by sequence labeling model trainer 109 to learn sequence labeling model 111 from IOBs 107 generated by IOB generator 105, according to a possible implementation of the present invention.

In a possible implementation, sequence labeling model 111 is a linear-chain Conditional Random Field (CRF) model. For example, model 111 can encompass a first-order Markov Conditional Random Field model with state and transitions features (dyad features). State features can be conditioned on combinations of attributes and labels, and transition features can be conditioned on label bigrams.

Where model 111 is a linear-chain Conditional Random Field model, model trainer 109 can train model 111 according to a variety of different training algorithms including:
(1) limited-memory Broyden-Fletcher-Goldfarb-Shanno method (L-BFGS),
(2) Stochastic Gradient Descent with L2 regularization (SGD),
(3) averaged perceptron,
(4) Passive Aggressive (PA), or
(5) Adaptive Regularization Of Weight vector (AROW).

With the L-BFGS method, model trainer 109 can maximize the logarithm of the likelihood of the training data with L1 and/or L2 regularization term(s) using the Limited-memory Broyden-Fletcher-Goldfarb-Shanno (L-BFGS) method. When a non-zero coefficient for L1 regularization term is specified, the L-BFGS method can switch to the Orthant-Wise Limited-memory Quasi-Newton (OWL-QN) method. In practice, the L-BFGS method can improve feature weights very slowly at the beginning of a training process, but converges to the optimal feature weights quickly in the end.

With the SGD method, model trainer 109 can maximize the logarithm of the likelihood of the training data with L2 regularization term(s) using Stochastic Gradient Descent (SGB) with a batch size of one (1). The SGD method can approach the optimal feature weights quite rapidly, but shows slow convergences at the end.

When a current model parameter cannot predict an item sequence correctly, the averaged perceptron method can apply perceptron updates to the model. The averaged perceptron algorithm can take the average of feature weights at all updates in the training process. The averaged perception algorithm can be fastest in terms of training speed, yet still exhibit highly accurate prediction performance. Model trainer 109 can stop a training process by specifying a maximum number of iterations (e.g., ten) where the maximum number of iterations can be tuned on a development set.

Given an item sequence (x, y) in the training data, the Passive Aggressive method can compute the loss: s(x, y′)−s(x, y)+sqrt(d(y′, y)), where s(x, y′) is the score of the Viterbi label sequence, s(x, y) is the score of the label sequence of the training data, and d(y′, y) measures the distance between the Viterbi label sequence (y′) and the reference label sequence (y). If the item suffers from a non-negative loss, the passive aggressive algorithm can update the model based on the loss.

Given an item sequence (x, y) in the training data, the AROW method can compute the loss: s(x, y′)−s(x, y), where s(x, y′) is the score of the Viterbi label sequence, and s(x, y) is the score of the label sequence of the training data.

More information on Conditional Random Field (CRF) models and training algorithms therefore can be found in the following papers, the entirety of each of which is hereby incorporated by reference:
1. Galen Andrew and Jianfeng Gao. “Scalable training of L1-regularized log-linear models”. Proceedings of the 24th International Conference on Machine Learning (ICML 2007). 33-40. 2007.
2. Koby Crammer, Ofer Dekel, Joseph Keshet, Shai Shalev-Shwartz, and Yoram Singer. “Online Passive-Aggressive Algorithms”. Journal of Machine Learning Research. 7. March 551-585. 2006.
3. Michael Collins. “Discriminative training methods for hidden Markov models: theory and experiments with perceptron algorithms”. Proceedings of the Conference on Empirical Methods in Natural Language Processing (EMNLP 2002). 1-8. 2002.
4. John Lafferty, Andrew McCallum, and Fernando Pereira. “Conditional Random Fields: Probabilistic Models for Segmenting and Labeling Sequence Data”. Proceedings of the 18th International Conference on Machine Learning. 282-289. 2001.
5. Robert Malouf. “A comparison of algorithms for maximum entropy parameter estimation”. Proceedings of the 6th conference on Natural language learning (CoNLL-2002). 49-55. 2002.
6. Avihai Mejer and Koby Crammer. “Confidence in Structured-Prediction using Confidence-Weighted Models”. Proceedings of the 2010 Conference on Empirical Methods in Natural Language Processing (EMNLP 2010). 971-981. 2010.
7. Jorge Nocedal. “Updating Quasi-Newton Matrices with Limited Storage”. Mathematics of Computation. 35. 151. 773-782. 1980.
8. Lawrence R. Rabiner. “A tutorial on hidden Markov models and selected applications in speech recognition”. Readings in speech recognition. 267-296. 1990. Morgan Kaufmann Publishers Inc., San Francisco, Calif., USA.
9. Fei Sha and Fernando Pereira. “Shallow parsing with conditional random fields”. NAACL '03: Proceedings of the 2003 Conference of the North American Chapter of the Association for Computational Linguistics on Human Language Technology. 134-141. 2003.
10. Shai Shalev-Shwartz, Yoram Singer, and Nathan Srebro. “Pegasos: Primal Estimated sub-GrAdient SOlver for SVM”. Proceedings of the 24th International Conference on Machine Learning (ICML 2007). 807-814. 2007.

While in a possible implementation, model 111 is a linear-chain Conditional Random Field (CRF) model and the sequence labeling training algorithm is one of the above-discussed training algorithms, model 111 can be another type of sequence labeling model and trained according to another type of sequence labeling training algorithm. For example, another type of sequence labeling model and algorithm suitable for solving sequence labeling problems and that use a feature map for learning can be used. Generally, in sequence labeling problems, the output is a sequence of labels y=(y¹, . . . , y^{T}) which corresponds to an observation sequence x=(x¹, . . . , x^{T}) In situations where each individual label can take values from set Σ, then the structured output problem can be considered as a multiclass classification problem with |Σ|^{T} different classes. Non-limiting examples of models and algorithms suitable for solving sequence labeling problems and that use a feature map include SVM^{multiclass}, SVM^{struct} and M³N.

More information on SVM^{multiclass} is available in the following paper which is hereby incorporated by reference in its entirety: Crammer, K., & Singer, Y. (2001). On the algorithmic implementation of multiclass kernel-based vector machines. Journal of Machine Learning Research, 2, 265-292.

More information on SVM″ is available in the following paper which is hereby incorporated by reference in its entirety: Tsochantaridis, I., Joachims, T., Hofmann, T., & Altun, Y. (2005). Large margin methods for structured and interdependent output variables. Journal of Machine Learning Research, 6, 1453-1484.

More information on M³N is available in the following paper which is hereby incorporated by reference in its entirety: Taskar, B., Guestrin, C., & Koller, D. (2003). Maxmargin markov networks. Advances in Neural Information Processing System 16.

Summarizing operations 300, sequences of IOB tagged tokens of IOBs 107 are converted 335 to corresponding sequences of labeled training items. Recall from description above that each sequence of IOB tagged tokens can correspond to a window of text read 213 from training examples 103. Thus, each sequence of labeled training items can also correspond to the window of text read 213 from training examples 103 to which the corresponding sequence of IOB tagged tokens corresponds.

A sequence of labeled training items can contain a labeled training item for each IOB tagged token in the corresponding sequence of IOB tagged tokens. Recall from description above that each IOB tagged token of a sequence of IOB tagged tokens can correspond to a token adaptively tokenized 215 from the window of text to which the sequence of IOB tagged tokens corresponds. Thus, a labeled training item of a sequence of labeled training items can also correspond to the token to which the corresponding IOB tagged token corresponds.

The labeled training item correspond to an IOB tagged token can include generated 337 local heading features for the corresponding IOB tagged token and generated 339 heading context features for the corresponding IOB tagged token. Features 337 and 339 can be used by model trainer 109 to learn model 111. As described in greater detail below, a labeled training item can be labeled with a more-granular IOB tag label for purposes of model trainer 109 training model 111 to accurately predict headings in unstructured text. After sequences of IOB tagged tokens in IOBs 107 are converted 335 to corresponding sequences of labeled training items that incorporate the generated 337, 339 local and heading context features, model trainer 109 trains 343 model 111 based on the sequences of labeled training items. Model trainer 109 then tests 345 and stores 347 the learned model 111.

Returning to the top of operations 300, IOBs 107 can contain sequences of IOB tagged tokens in a heading IOB format where each sequence of IOB tagged tokens corresponds to a window of text in training examples 103. Model trainer 109 can convert 335 the sequences of IOB tagged tokens of IOBs 107 to corresponding sequences of labeled training items for purposes of training model 111 in a supervised machine leaning manner. To convert 335 a sequence of IOB tagged tokens into a corresponding sequence of labeled training items, model trainer 109 can perform operations 337, 339, and 341 for each IOB tagged token in each sequence of IOB tagged tokens in IOBs 107.

As a result of converting 335 a sequence of IOB tagged tokens into the corresponding sequence of labeled training items, each generated 341 labeled training item encompasses an IOB tag label according to a heading IOB format, a set of generated 337 local heading features, and a set of generated 339 heading context features.

The IOB tag label of a labeled training item can be based on the IOB tag of the corresponding IOB tagged token. In particular, if the corresponding IOB tagged token is IOB tagged as beginning or inside a header (e.g., as “B-HEADING” or “I-HEADING”), then the IOB tag label for the labeled training item can be a more granular IOB tag according to a heading IOB format. A heading IOB format distinguishes at least between tokens in a heading that are punctuation and whitespace tokens, tokens in a heading that are numbers, and word, punctuation, and whitespace tokens in a heading that are part of a heading title.

On the other hand, if the corresponding IOB tagged token is IOB tagged according to a heading IOB format as beginning or inside other text e.g., “B-OTHER” or “I-OTHER”)., then the IOB tag from the IOB tagged token can be retained as the IOB tag label in the labeled training item.

Given a target IOB tagged token of a target sequence of IOB tagged tokens where the IOB tagged token is part of a heading according to its IOB tag (e.g., “B-HEADING” or “I-HEADING”), model trainer 109 can select one of the following IOB tag labels for the corresponding target labeled training item: B-PUNC, B-NUMBER, B-TITLE, B-OTHER, I-PUNC, I-NUMBER, I-TITLE, and I-OTHER.

One skilled in the art will recognize that different IOB tag names can be used and that these particular IOB tag names are not required of the present invention. One skilled in the art will also recognize that IOB tag names are not required to be in IOB tag format and that the IOB tag format is simply used as a convenient string data format for labeling the training items.

Model trainer 109 can employ various different rules for assigning an IOB tag label to the corresponding target labeled training item. In general, however, the B-PUNC and I-PUNC IOB tag labels can be used for punctuation and whitespace tokens in a heading. The B-NUMBER and I-NUMBER IOB tag labels can used for used for number tokens in a heading including numerical digits (e.g., “1,” “123”, “0”, “12341245234”, etc.), uppercase or lowercase roman numerals (e.g., “I”, “III”, “X”, “IV”, etc.), uppercase, lowercase, or mixed case text ordinals (e.g., “first,” “second,” “third”, etc.; “1^{st}”, “2^{nd}”, “3^{rd}”, etc.), uppercase or lowercase letter ordinals (e.g., “a”, “b”, “c”, etc.; “A”, “B”, “C”, etc.), or the like. The B-TITLE and I-TITLE IOB tag labels can be used for word and whitespace tokens make up a heading title.

Returning to a previous example sequence of IOB tagged tokens, the IOB tagged tokens can have the following corresponding IOB tag labels in the corresponding labeled training item.

| Token | IOB Tag | Training Item Label |
|---|---|---|
| Open parentheses token. | B-HEADING | B-PUNC |
| Word token “e”. | I-HEADING | B-NUMBER |
| Close parentheses token. | I-HEADING | B-PUNC |
| Space token. | I-HEADING | I-PUNC |
| Word token “Payment”. | I-HEADING | B-TITLE |
| Space token. | I-HEADING | I-TITLE |
| Word token “of” | I-HEADING | I-TITLE |
| Space token. | I-HEADING | I-TITLE |
| Word token “Stamp” | I-HEADING | I-TITLE |
| Space token. | I-HEADING | I-TITLE |
| Word token “Tax”. | I-HEADING | I-TITLE |
| Full stop token. | I-HEADING | B-PUNC |
| Space token. | B-OTHER | B-OTHER |
| Word token “Subject”. | I-OTHER | I-OTHER |
| Space token. | I-OTHER | I-OTHER |
| Word token “to”. | I-OTHER | I-OTHER |
| Space token. | I-OTHER | I-OTHER |
| Word token “Section”. | I-OTHER | I-OTHER |
| Space token. | I-OTHER | I-OTHER |
| Number token “11”. | I-OTHER | I-OTHER |
| Comma token. | I-OTHER | I-OTHER |
| Space token. | I-OTHER | I-OTHER |
| Word token “it”. | I-OTHER | I-OTHER |
| Space token. | I-OTHER | I-OTHER |
| Word token “wil”. | I-OTHER | I-OTHER |

The above-example is just one example of how the example sequence of IOB tagged tokens might be assigned IOB tag labels for the corresponding sequence of labeled training items. In general, however, the labeled training items corresponding to the IOB tagged tokens that are part of a heading are assigned IOB tag labels that differentiate the tokens of the heading on the basis of different semantic parts of a heading including title, punctuation, and number. On the other hand, the labeled training items corresponding to the IOB tagged tokens that are not part of a heading (e.g., part of other text) are not so differentiated. This different training item labeling treatment, that depends on whether the corresponding tokens are part of or not part of a heading, aids model trainer 109 in learning model 111 that can accurately predict text in unstructured text document 104 that are headings.

### Local Heading Features

At operation 337, model trainer 109 can generate various different local heading features for a current IOB tagged token being converted 335 to a labeled training data item. Local heading features are features about the current token. In a possible implementation, all of the following local heading features are generated for the current IOB tagged token, a subset of these features, or a superset of a subset:

| Feature Name | Description |
|---|---|
| w | The current token itself as a sequence of text characters. As an |
| | alternative, a word embedding representation (e.g., a word |
| | vector) of current token can be used. The word vector for the |
| | current token can be pre-training for the current token such as, |
| | for example, a pre-trained GloVe vector for the current token. |
| | More information on GloVe is available on the Internet at |
| | /projects/glove in the nlp.stanford.edu domain, the entire |
| | contents of which is hereby incorporated by reference. |
| single_lowercase_letter | Binary feature indicating whether the current token consists of a |
| | single lowercase letter character. This is a useful feature for |
| | unstructured text documents where the numbering of headings is |
| | by single lowercase letters (e.g., ‘a’, ‘b’, etc.). |
| double_lowercase_letter | Binary feature indicating whether the current token consists of |
| | two lowercase letter characters. When single letter options run |
| | out for headings, authors sometime use double letters (e.g., ‘aa’ |
| | after ‘z’). |
| single_uppercase_letter | Binary feature indicating whether the current token consists of a |
| | single uppercase letter character. This is a useful feature for |
| | unstructured text documents where the numbering of headings is |
| | by single uppercase letters (e.g., ‘A’, ‘B’, etc.). |
| open_paren | Binary feature indicating whether the current token consists of a |
| | single left parenthesis character (e.g., ‘(’). |
| close_paren | Binary feature indicating whether the current token consists of a |
| | single right parenthesis character (e.g., ‘)’). |
| space | Binary feature indicating whether the current token consists of a |
| | single space character. |
| digit | Binary feature indicating whether the current token consists of |
| | numerical digits only. |
| lowercase_roman_number | Binary feature indicating whether the current token consists of a |
| | lowercase roman numeral (e.g., ‘i’, ‘ii’, ‘iii’, etc.). |
| uppercase_roman_number | Binary feature indicating whether the current token consists of a |
| | upercase roman numeral (e.g., ‘I’, ‘II’, ‘III’, etc.). |
| full_stop | Binary feature indicating whether the current token consists of a |
| | single full stop character (e.g., ‘.’). |
| newline | Binary feature indicating whether the current token consists of a |
| | single newline character (e.g., ‘.’). |
| istitlecased | Binary feature indicating whether the current token consists of a |
| | sequence of title cased characters. A token is title cased when its |
| | first text character is uppercase and any following text characters |
| | are all lowercase. |
| isupper | Binary feature indicating whether the current token consists of |
| | all uppercase text characters. |
| is_first_non_whitespace | Binary feature indicating whether the current token is the first |
| | token that is not a whitespace token in the heading to which the |
| | current token belongs. |

In the above examples, the feature names are provided for reference as examples of descriptive feature names only and are not required of the present invention.

### Heading Context Features

At operation 339, model trainer 109 can generate various different heading context features for a current IOB tagged token being converted 335 to a labeled training data item. Heading context features encompass features about tokens surrounding the current token in the heading in which the current token occurs.

In a possible implementation, any of the local heading features discussed above for other tokens in the heading in which the current token occurs can be generated as heading context features for the current token. For example, a heading context features for the current token can be whether the first, second, or third token preceding or following the current token in the heading is single_lowercase_letter, close_paren, space, digit, roman_number, etc.

A heading context feature for the current token can be a combination of a local heading feature for the current token and one or more features of one or more surrounding tokens in the heading in which the current token occurs. For example, a heading context feature for the current token can be a binary feature that is true or positive, and false or negative otherwise, when all of the following are true or positive:
The current token is open_paren,
The first token following the current token in the heading is single_lowercase_letter,
The second token following the current token in the heading is close_paren, and
The third token following the current token in the heading is space.

For example, this heading context feature would be true or positive for a heading that contains “(a)” (double-quotes not part of heading).

As another example, a heading context feature for the current token can be a binary feature that is true or positive, and false or negative otherwise, when all of the following are true or positive:
The current token is open_paren,
The first token following the current token in the heading is digit, and
The second token following the current token in the heading is close_paren.

For example, this heading context feature would be true or positive for a heading that contains “(1)” (double-quotes not part of heading).

As another example, a heading context feature for the current token can be a binary feature that is true or positive, and false or negative otherwise, when all of the following are true or positive:
The current token is open_paren,
The first token following the current token in the heading is single uppercase letter, and
The second token following the current token in the heading is close_paren.

For example, this heading context feature would be true or positive for a heading that contains “(A)” (double-quotes not part of heading).

As yet another example, a heading context feature for the current token can be a binary feature that is true or positive, and false or negative otherwise, when all of the following are true or positive:
The current token is open_paren,
The next token following the current token in the heading is roman_number,
The next token after that token in the heading is close_paren, and
The third token after that toke in the heading is space.

For example, this heading context feature would be true or positive for a heading that contains “(I)” (double-quotes not part of heading).

As yet another example, a heading context feature for the current token can be a binary feature that is true or positive, and false or negative otherwise, when all of the following are true or positive:
The current token is open_paren,
The next token following the current token in the heading is roman_number,
The next token after that token in the heading is close_paren,
The third token after the current token in the heading is space, and
The fourth token after the current token in the heading is istitlecased.

For example, this heading context feature would be true or positive for a heading that contains “(I) Disclosures” (double-quotes not part of heading).

As yet another example, a heading context feature for the current token can be a binary feature that is true or positive, and false or negative otherwise, when all of the following are true or positive:
The current token is digit,
The next token following the current token in the heading is full stop, and
The next token after that token in the heading is space.

For example, this heading context feature would be true or positive for a heading that contains “1.” (double-quotes not part of heading).

As yet another example, a heading context feature for the current token can be a binary feature that is true or positive, and false or negative otherwise, when all of the following are true or positive:
The current token is digit,
The next token following the current token in the heading is full stop,
The next token after that token in the heading is space, and
The third token after the current token in the heading is newline.

For example, this heading context feature would be true or positive for a heading that contains “1. \n” (double-quotes not part of heading; ‘\n’ used to represent the newline character).

As yet another example, a heading context feature for the current token can be a binary feature that is true or positive, and false or negative otherwise, when all of the following are true or positive:
The current token is isupper,
The first token preceding the current token in the heading is space,
The second token preceding the current token in the heading is full stop, and
The third token preceding the current token in the heading is digit.

For example, this heading context feature would be true or positive for a heading that contains “1. A” (double-quotes not part of heading).

The above are just some examples of a possible heading context feature for the current token that is a combination of a local heading feature for the current token and one or more features of one or more surrounding tokens in the heading in which the current token occurs.

### Training

Once the sequences of IOB tagged tokens in IOBs 107 are converted 335 to sequences of labeled training items in accordance with operations 337, 339, and 341, model trainer 109 can train 343 sequence labeling model 111 based on the generated 341 sequences of labeled training items.

Each sequence of labeled training items can correspond to a sequence of IOB tagged tokens in IOBs 107 which can correspond to a window of text from training examples 103. Each labeled training item can correspond to an IOB tagged token and can have an IOB tag training label for the token according to a heading IOB format. For example, a heading IOB format can include all of the following IOB tag training labels, a subset of these labels, or a superset of a subset:
B-PUNC—For a punctuation token or a whitespace token beginning a sequence of one or more tokens in a heading.
B-NUMBER—For a number token beginning a sequence of one or more tokens in a heading. The number token can be a multi-character token and can include digit numbers as well as non-digit numbers such as uppercase and lowercase roman numerals, uppercase and lowercase letter numbers and uppercase, lowercase, or mixed-case text ordinals.
B-TITLE—For a word token beginning a sequence of one or more tokens in a heading title.
B-OTHER—For a token that begins a sequence of one or more tokens in other text.
I-PUNC—For a token inside a sequence of two or more tokens in a heading where the sequence begins with a punctuation token or a whitespace token.
I-NUMBER—For a token inside a sequence of two or more tokens in a heading where the sequence begins with a number token.
I-TITLE—For a token inside a sequence of two or more tokens in a heading title where the sequence begins with a word token.
I-OTHER—For a token inside a sequence of one or more tokens in other text.

Each labeled training item for an IOB tagged token can associate with the IOB tag training label one or more local heading features and/or one or more heading context features generated 337 and/or 339 for the token.

Training 343 can involve using a graphical model for feature generation such as, for example, the first-order Markov conditional random field (CRF) with state and transition features (dyad features) and maximizing the log-likelihood of the conditional probability distribution. State features can be conditioned on combinations of (a) local heading features and heading context features and (b) IOB tag labels of the sequences of labeled training items. Model trainer 109 can perform a training algorithm when training 343 such as, for example, one of the following training methods discussed above: Gradient descent using the L-BFGS method, Stochastic Gradient Descent with L2 regularization term, Average Perceptron, Passive Aggressive, or Adaptive Regularization Of Weight vector.

In a possible implementation, when training 343, model trainer 109 uses all state and transition features conditioned on the sequences of labeled training items and does not cut-off state and transition features having a frequency of occurrence conditioned on the sequences of labeled training items below a threshold.

In a possible implementation, when training 343, model trainer 109 does not generate state transition features that associate all possible combinations of (a) training item features (e.g., the local heading features and the heading context features of the training item) of the sequences of labeled training items and (b) IOB tag labels of the sequences of labeled training items. This is done in order to speed up training 343 operation. However, model trainer 109 can generate all such possible combinations in order to learn model 111 with greater labeling accuracy at the expense of training time.

In a possible implementation, when training 343, model trainer 109 generates transition features for the first-order Markov conditional random field (CRF) for all possible IOB tag label pairs in the sequences of labeled training items even if transitions do not occur in the sequence of labeled training items. For example, if the possible IOB tag labels include the following eight (8) IOB tag labels: B-PUNC, B-NUMBER, B-TITLE, B-OTHER, I-PUNC, I-NUMBER, I-TITLE, and I-OTHER, then model trainer 109 can generate (8*8)=64 transition features even if there is no transition in a sequence of labeled training items from, for example, a B-NUMBER labeled training item to a I-NUMBER labeled training item.

In a possible implementation, model trainer 109 performs the Gradient descent using the L-BFGS method to learn model 111 from the sequences of labeled training items. When performing the L-BFGS method, model trainer 109 does not perform L1 regularization, uses a coefficient of one (1) for L2 regularization, performs up to the maximum number of iterations for L-BFGS optimization, uses six limited memories for approximating the inverse hessian matrix, uses a ten iteration duration to test the stopping criterion which is whether the improvement of the log likelihood over the last ten iterations is no greater than the epsilon parameter of (1e-5), and uses the More and Thuente line search method with a maximum number of twenty trials.

Once model 111 is learned as a result of model trainer 109 performing training 343 operation, model trainer 109 can test 345 model 111 against a set of testing items with known labels to determine model 111's labeling accuracy. For example, model 11 can be tested for accuracy, precision, recall, and/or f1 score on the set of testing items. Finally, model 111 can be stored 347 in storage media in a file or other data container. Model 111 as stored 347 may include the final state and transition (dyad) feature weights of the first-order Markov conditional random field (CRF) assigned by model trainer 109 as a result of performing training 343 operation.

The above is provided as an illustration of a possible way for model trainer 109 to train model 111 based on the sequences of labeled training items. One skilled in the art will recognize that different ways for model trainer 109 to train model 111 based on the sequence of labeled training items are possible according to the requirements of the particular implementation at hand and the particular local heading features and heading context features generated 337 and 339.

### Auto-Tagger—Heading Prediction

FIG. 4 is a flowchart of example processing operations 400 performed by auto-tagger 106 to predict text of unstructured text document 104 that belongs to a heading using learned sequence labeling model 111, according to a possible implementation of the present invention. While FIG. 1 depicts just unstructured text document 104, operations 400 can be performed for multiple different unstructured text documents to predict the headings in the multiple different documents of which unstructured text document 104 is just one example.

Unstructured text document 104 can be virtually any unstructured text document containing headings. For example, unstructured text document 104 can be a legal document such as, for example, a written legal contract or other written legal agreement. In a possible implementation, unstructured text document 104 is an International Swap and Derivatives Agreement (ISDA).

Operations 412, 414, and 422 are performed for each window of text read from unstructured text document 104. Operations 416, 418, and 420 are performed for each token tokenized 412 from each window. While windows of text can be read from unstructured text document 104 in the same manner that windows of text are read from training examples 103, this is not required of the present invention. Size(s) and length(s) of windows read from unstructured text document 104 can be the same or different than the size(s) and length(s) of windows read from training examples 103. The criterion for selecting the next window of text to read from unstructured text document 104 can be the same or different than the criterion used to select the next window of text to read from training examples 103. For example, each window of consecutive text characters read from unstructured text document 104 can correspond to a line of text or a sentence, clause, paragraph, or other grammatical unit of text or a predefined number of consecutive text characters in unstructured text document 104. Likewise, with the windows of text read from training examples 103. Alternatively, different window selection criteria can be used to read windows of text from unstructured text document 104 and training examples 103.

At operation 412, the current window of text is adaptively tokenized. This adaptive tokenization can occur in the same manner as windows of text read from training examples 103 are adaptively tokenized at operation 215 described above. In particular, punctuation tokens and whitespace tokens can be tokenized from the current window of text as single-character tokens. As a result, each punctuation and/or whitespace character in the current window of text can be tokenized as a single-character token. Number tokens and word tokens can be tokenized from the current window of text as multi-character tokens. As a result, a sequence of two or more consecutive number characters in the current window of text can be tokenized as a multi-character number token. Likewise, a sequence of two or more consecutive word characters in the current window of text can be tokenized as a multi-character word token. Individual number characters and individual word characters occurring in the current window of text can also be tokenized as a single-character number token or a single-character word token, respectively, if they do not occur consecutively in the current window of text with another number character or word character, respectively.

Operations 416, 418, and 420 are performed for each token tokenized 412 from the current window.

At operation 416, local heading features are generated for the current token. For example, local heading features can be generated 416 for the current token in a manner analogous to that described above with respect to operation 337.

At operation 418, heading context features are generated for the current token. For example, heading context features can be generated 418 for the current token in a manner analogous to that described above with respect to operation 339.

At operation 420, a sample item is generated for the current token comprising the local heading features generated 416 and the heading context features generated 418.

After operations 416, 418, and 420 are performed for each token in the current window, a sequence of sample items is generated where the sequence of sample items includes each sample item generated 420 for each token in the current window. The order of the sample items in the sequence corresponds to the order of occurrence of the tokens in the current window.

Operations 412, 414, and 422 can be performed for each window of text read from unstructured text document 104 to generate sequences of sample items. For example, a sequence of sample items can be generated for each window of text read from unstructured text document 104.

At operation 424, learned sequence labeling model 111 is used to tag sample items in the sequences of sample items generated from unstructured text document 104. In particular, each sample item of each sequence of sample item can be tagged based on the local heading features generated 416 and the heading context features generated 418 for the sample item. Sample items can be tagged in order of the sample items in the sequences of sample items.

As a result of operation 424, model 111 is used to generate a tag for each token tokenized 412 from unstructured text document 204. The tag assigned to a sample item/token by model 111 can be one of a predefined set of tags. In a possible implementation, the predefined set of tags include the IOB tag labels according to a heading IOB format. In particular, model 111 can assign one of the following tags to each sample item: B-PUNC, B-NUMBER, B-TITLE, B-OTHER, I-PUNC, I-NUMBER, I-TITLE, or I-OTHER. For example, model 111 can assign the most probable of these tags to a sample item. As mentioned previously, these tag names are relatively arbitrary and different tag names with analogous semantics can be used in a possible implementation.

As a result of performing operations 400, each token tokenized 412 from unstructured text document 104 is assigned a tag by model 111 that indicates whether the token is most likely one of:
A punctuation token or whitespace token beginning a sequence of one or more tokens in a heading (B-PUNC),
A number token beginning a sequence of one or more tokens in a heading (B-NUMBER),
A word token beginning a sequence of one or more tokens in a heading title (B-TITLE),
A token beginning a sequence of one or more tokens in other text, (B-OTHER)
A token inside a sequence of two or more tokens in a heading where the sequence begins with a punctuation token (I-PUNC),
A token inside a sequence of two or more tokens in a heading where the sequence begins with a number token (I-NUMBER),
A token inside a sequence of two or more tokens in a heading title wherein the sequence begins with a word token (I-TITLE), or
A token inside a sequence of one or more tokens in other text (I-OTHER).

As described in greater detail in the next section, the sequence of tags assigned by model 111 to the sequence of tokens in unstructured text document 104 are used by model trainer 109 to determine which tokens in unstructured text document 104 belong to a heading.

### Auto-Tagger—Section Boundary Detection

FIG. 5 is a flowchart of example processing operations performed by auto-tagger 106 to identify the boundaries of sections in unstructured text document 104, according to a possible implementation of the present invention. While FIG. 1 depicts just unstructured text document 104, operations 500 can be performed for multiple different unstructured text documents to identify the boundaries of sections in the multiple different documents of which unstructured text document 104 is just one example.

Operation 526 can be performed for each window of text in unstructured text document 104. Operation 526 can be performed for each window in order in which the windows occur in unstructured text document 104 when reading unstructured text document 104 from beginning to end. In particular, it is determined 256 whether the current window of text contains a token that starts a heading. This determination 256 can be made based on the tags assigned to the tokens in the current window as a result of using model 111 to tag the tokens such as, for example, as described above with respect to operation 400 of FIG. 4

In a possible implementation, it is determined 256 that the current window starts a heading if the current window contains at least one token tagged with any of the beginning heading IOB format tags. For example, the first token in the current window that is tagged as any of B-PUNC, B-NUMBER, or B-TITLE can be taken as the start of a heading.

In a possible implementation, it is determined 526 that the current window does not start a heading if the current window only contains tokens tagged as B-PUNC, I-PUNC, B-OTHER or I-OTHER. Thus, in a possible implementation, it can be determined 526 that the current window starts a heading only if the current window contains at least one token tagged as B-NUMBER or B-TITLE.

If it is determined 256 that the current window does not start a heading, then operations 500 proceed 258 to the next window of unstructured text document 104, if there is one. If the current window does not start a heading and there are no more windows of unstructured text document 104 to process, the operations 500 end.

On the other hand, if it is determined 256 that the current window does start a heading, then a section boundary is set based on the start of the heading in unstructured text document 104. In particular, the start of a new section containing the heading is the first text character of the heading in unstructured text document 104. The text character immediately preceding the first text character in the heading ends the previous section, if there is a previous section. Thus, all sections can start with a heading and identification of a start of a heading in a window can end a previous section and start a new section.

While it is possible for a section to end where a new section starts, it is also possible for a section to end at another type of detected boundary. For example, a section can end based on detecting the start of other text that is not a heading. For example, the other text might be a signature block, table, figure, formula, equation, page footnote, page header, page number, embedded comment or note, or other portion of unstructured text document 104 that is not a heading but that nonetheless starts a new semantic portion of unstructured text document 104 that should not be included in the section. The start of the other text can be detected according to a variety of different techniques including, for example, according to statistical natural language processing techniques. Thus, while a section can start with a heading, it need not end at the start of a heading of a next section and may instead end at the start of other text that follows the section in unstructured text document 104.

Along the same lines, the text of unstructured text document 104 that is considered part of a section that starts with an identified heading may skip or omit some of the following text even where the section ends at the heading of a next section. For example, a signature block, table, figure, formula, equation, page footnote, page header, page number, embedded comment or note, or other portion of unstructured text document 104 that is in the middle the section can be omitted from the text of the section.

As an example of operation 530, consider the following snippet of unstructured text consisting of three lines of text and in which the newline character is represented with the UNICODE escape sequence \u000A.
01: (e) Payment of Stamp Tax. Subject to Section 11, it will pay any Stamp Tax levied imposed upon it or in respect of its execution or performance of this Agreement by a jurisdiction in which it is incorporated, organised, managed and controlled, or considered to have its seat, or in which a branch or office through which it is acting for the purpose of this Agreement is located (“Stamp Tax Jurisdiction”) and will indemnify the other party against any Stamp Tax levied or imposed upon the other party or in respect of the other party's execution or performance of this Agreement by any such Stamp Tax Jurisdiction which is not also a Stamp Tax Jurisdiction with respect to the other party.\u000A
02: 5. Events of Default and Termination Events\u000A
03: (a) Events of Default. The occurrence at any time with respect to a party or, if applicable, any Credit Support Provider of such party or any Specified Entity of such party of any of the following events constitutes an event of default (an “Event of Default”) with respect to such party:—\u000A

In the example below, the text characters enclosed in << >> and bolded identify a detected start of a heading. The << >> notation and bolding are used to identify the text characters for purposes of this disclosure and are not part of the unstructured text.
01: <<(>>e) Payment of Stamp Tax. Subject to Section 11, it will pay any Stamp Tax levied imposed upon it or in respect of its execution or performance of this Agreement by a jurisdiction in which it is incorporated, organised, managed and controlled, or considered to have its seat, or in which a branch or office through which it is acting for the purpose of this Agreement is located (“Stamp Tax Jurisdiction”) and will indemnify the other party against any Stamp Tax levied or imposed upon the other party or in respect of the other party's execution or performance of this Agreement by any such Stamp Tax Jurisdiction which is not also a Stamp Tax Jurisdiction with respect to the other party.\u000A
02: <<5>>. Events of Default and Termination Events\u000A
03: <<(>>a) Events of Default. The occurrence at any time with respect to a party or, if applicable, any Credit Support Provider of such party or any Specified Entity of such party of any of the following events constitutes an event of default (an “Event of Default”) with respect to such party:—\u000A

With this example, the following sections might be identified. Here, XML-like markup is used to identify where each section starts and where each section ends. The XML-like notation is used to identify the text characters including the sections for purposes of this disclosure and are not part of the unstructured text.
01: <SECTION>(e) Payment of Stamp Tax. Subject to Section 11, it will pay any Stamp Tax levied imposed upon it or in respect of its execution or performance of this Agreement by a jurisdiction in which it is incorporated, organised, managed and controlled, or considered to have its seat, or in which a branch or office through which it is acting for the purpose of this Agreement is located (“Stamp Tax Jurisdiction”) and will indemnify the other party against any Stamp Tax levied or imposed upon the other party or in respect of the other party's execution or performance of this Agreement by any such Stamp Tax Jurisdiction which is not also a Stamp Tax Jurisdiction with respect to the other party.\u000A</SECTION>
02: <SECTION>5. Events of Default and Termination Events\u000A</SECTION>
03: <SECTION>(a) Events of Default. The occurrence at any time with respect to a party or, if applicable, any Credit Support Provider of such party or any Specified Entity of such party of any of the following events constitutes an event of default (an “Event of Default”) with respect to such party:—\u000A</SECTION>

In this example, for a given section, all text characters from the first text character of the heading of the section to the last text character before the first text character of the heading of the next section are included in the given section. In this example, the last character in each section is the newline character (\u000A).

### Auto-Tagger—Hierarhical Relationships Between Sections

FIG. 6 is a flowchart of example processing operations performed by auto-tagger 106 to determine the hierarchical relationships between identified sections in unstructured text document 104, according to a possible implementation of the present invention. While FIG. 1 depicts just unstructured text document 104, operations 600 can be performed for multiple different unstructured text documents to identify the boundaries of sections in the multiple different documents of which unstructured text document 104 is just one example.

In a possible implementation, the hierarchical relationships between identified sections in unstructured text document 104 are determined based on detected changes in numbering styles used in the headings of the section. In general, each section identified in unstructured text document 104 can be assigned to a level in a hierarchy of the sections based on the heading numbering style used in the heading of the section. Each section can be assigned to a level in the hierarchy in the order in which the sections occur in unstructured text document 104. The top level in hierarchy can be assigned level 1, for example, and may correspond to the heading numbering style used in the first section of unstructured text document 104. When a new numbering style is identified, then a new level in the hierarchy can be created as a child level of the current level and the section with the new numbering style can be assigned to the new level. When a section is encountered where the heading in the section uses a previously identified numbering style, then the section can be assigned to the level in the hierarchy previously created for that previously identified numbering style.

Starting at the top of FIG. 6, some operations 632 can be performed for each section identified in unstructured text document 104 in order of the sections in unstructured text document 104 as in, for example, a loop.

At operation 634, starting with the first section of unstructured text document 104, the heading numbering style of the heading of the current section is determined. In a possible implementation, the heading numbering style of the heading is determined by matching the heading of the current section to a regular expression that represents the heading numbering style. There may be a number of different heading numbering styles and a corresponding different number of different regular expressions. In general, however, the different heading numbering styles reflected by the set of regular expressions used can reflect the different types of heading numbering styles used in a corpus of unstructured text documents such as, for example, a corpus of ISDA agreements, as just one example.

In a possible implementation, each of the following different example headings represent different heading numbering styles. In the column of the table provide the example headings, double-quotes are used to represent the heading for purposes of this disclosure but are not considered to be part of the heading.

| Example of Heading | |
|---|---|
| Numbering Style | Description |
| “1” | The corresponding regular expression can match a number token |
| | expressed as numerical digits followed by a whitespace token as |
| | in, for example: |
| | “ [1-9][0-9]*\s$” |
| “1.” | The corresponding regular expression can match a number token |
| | expressed as numerical digits, followed by a full top token, |
| | followed by a whitespace token as in, for example: |
| | “\hat{ } [1-9][0-9]*\.\s*$” |
| “(a)” | The corresponding regular expression can match a left |
| | parentheses token, followed by a number token expressed as a |
| | lowercase letter ordinal, followed by a right parentheses token as |
| | in, for example: |
| | “\hat{ }\([a-z]{1,2}\s*\)\s*$” |
| “(ii)” | The corresponding regular expression can match a left |
| | parentheses token, followed by a lower-case roman numeral, |
| | followed by a right parentheses token as in, for example: |
| | “\hat{ }\([ivx]+\)$” |
| “(1)” | The corresponding regular expression can match a left |
| | parentheses token, followed by a number token expressed as |
| | numerical digits, followed by a right parentheses token as in, for |
| | example: |
| | “\hat{ }\([1-9][0-9]*\)$” |
| “(A)” | The corresponding regular expression can match a left |
| | parentheses token, followed by number token expressed as an |
| | uppercase letter ordinal, followed by a right parentheses token as |
| | in, for example: |
| | “\hat{ }\([A-Z]\)$” |
| “1.1” | The corresponding regular expression can match a number token |
| | expressed as numerical digits, followed by a full stop token, |
| | followed by another number token expressed as numerical digits, |
| | followed by a whitespace token as in, for example: |
| | “\hat{ }[1-9][0-9]*\.[0-9]+\.?\s*$” |
| “a.” | The corresponding regular expression can match a number token |
| | express as a lowercase letter ordinal, followed by a full stop |
| | token, followed by a whitespace token as in, for example: |
| | “\hat{ }[a-z]\.\s+$” |
| “iii.” | The corresponding regular expression can match a number token |
| | express as a lowercase letter ordinal, followed by a full stop |
| | token, followed by a whitespace token as in, for example: |
| | “\hat{ }[ivx]{1,3}\.\s+$” |

At operation 636, if the heading numbering style determined 634 for the current section is a new heading numbering style for unstructured text document 104 (i.e., the first section in unstructured text document 104 with the new heading numbering style), then a new level in the hierarchy of sections is created 638 for the new heading numbering style.

As an aside, the hierarchy of sections can be represented using any data structure suitable for representing the hierarchy such as, for example, a tree data structure. For example, the tree data structure can have a node in the tree for each section. The tree data structure can have one or more root nodes where each root node represents a section in the top level of the hierarchy. If there are multiple root nodes, the root nodes can be ordered in the tree such that they represent the order of the top-level sections in unstructured text document 104. A section that is in the next level of the hierarchy below the top-level can be represented by a node that is a child node of the root node in the hierarchy that the section is nested directly within in unstructured text document 104. Likewise, a section that is further nested within that child section in unstructured text document 104 can be represented by a grandchild node of the root node, and so on. At each level in the hierarchy, the nodes in the level can be ordered in the tree in order of the corresponding sections in unstructured text document 104. In this way, the tree data structure, or the like, can represent the sections in unstructured text document 104 and the hierarchical relationships therebetween.

At operation 638, a new level in the hierarchy of sections is created 638 for the new heading numbering style. If the current section is the first section in unstructured text document 104, then the new level is the top level in the hierarchy. If the current section is not the first section in unstructured text document 104, then the new level is created as a child level of the level of the section immediately prior to the current section in unstructured text document 104. At operation 640, the current section is assigned to the new hierarchal level as the first section in the new hierarchical level.

If the heading numbering style determined 634 for the current section is an existing heading numbering style of a previous section in unstructured text document 104, then the current section can be assigned 642 to the level in the hierarchy previously created for the existing heading numbering style. In this case, the current section can be assigned 642 as a child section of the most recent section assigned (640 or 642) to the previously created parent level of the previously created level in the hierarchy for the existing heading numbering style, if the previously created level in the hierarchy for the existing heading numbering style is not the top-level. If the previously created level in the hierarchy for the existing heading numbering style is the top-level, then the current section can be assigned 642 as a sibling section of the most recent section assigned (640 or 642) to the top-level in the hierarchy.

Operations 600 end when all sections in unstructured text document 104 have been assigned to a level in the hierarchy and an order within the level that corresponds to the order of the sections in unstructured text document 104.

### Structured Text Output

After determining the headings of unstructured text document 104 (e.g., by performing operations 400), identifying the sections of unstructured text document 104 (e.g., by performing operations 500), and determining the hierarchical relationships between the sections (e.g., by performing operations 600), structured text document 108 can be generated that identifies the heading, the sections, and the hierarchical relationships in a well-formed structured text document format such as, for example, eXtensible Markup Language (XML) or the like.

In a possible implementation, structured text document 108 is an XML document that confirms to a particular XML schema. In a possible implementation, the particular XML schema definition is as follows expressed in REgular LAnguage for XML Next Generation (RELAX NG) format:

| | |
|---|---|
| 001: | default namespace = “” |

002:

| | |
|---|---|
| 003: | start = |
| 004: | element collection { |

| | |
|---|---|
| 005: | document+ |

| | |
|---|---|
| 006: | } |

007:

| | |
|---|---|
| 008: | document = |

| | |
|---|---|
| 009: | element document { |

| | |
|---|---|
| 010: | attribute language { xsd:language }, |
| 011: | attribute relation { “attachment” \| “amendment” \| |

“amending_attachment” }?,

| | |
|---|---|
| 012: | element meta { |

| | |
|---|---|
| 013: | element keyvalue { |

| | |
|---|---|
| 014: | element key { string “source” }, |
| 015: | element value { text } |

| | |
|---|---|
| 016: | }, |

| | |
|---|---|
| 017: | element keyvalue { |

| | |
|---|---|
| 018: | element key { string “source_url” }, |
| 019: | element value { text } |

| | |
|---|---|
| 020: | }, |

| | |
|---|---|
| 021: | element keyvalue { |

| | |
|---|---|
| 022: | element key { string “tagger_type” }, |
| 023: | element value { text } |

| | |
|---|---|
| 024: | }, |

| | |
|---|---|
| 025: | element keyvalue { |

| | |
|---|---|
| 026: | element key { string “tagger_name” }, |
| 027: | element value { text } |

| | |
|---|---|
| 028: | }, |

| | |
|---|---|
| 029: | element keyvalue { |

| | |
|---|---|
| 030: | element key { string “tagger_version” }, |
| 031: | element value { text } |

| | |
|---|---|
| 032: | }, |

| | |
|---|---|
| 033: | element keyvalue { |

| | |
|---|---|
| 034: | element key { string “tagging_date” }, |
| 035: | element value { text } |

| | |
|---|---|
| 036: | }, |

| | |
|---|---|
| 037: | element keyvalue { |

| | |
|---|---|
| 038: | element key { string “schema_version” }, |
| 039: | element value { text } |

| | |
|---|---|
| 040: | } |

| | |
|---|---|
| 041: | }, |
| 042: | (clause \| page_break \| page_footer \| page_header)* |

| | |
|---|---|
| 043: | }+ |

044:

| | |
|---|---|
| 045: | page_break = element page_break { empty } |

046:

| | |
|---|---|
| 047: | page_footer = element page_footer { |

| | |
|---|---|
| 048: | attribute page_number { text }, |
| 049: | text } |

050:

| | |
|---|---|
| 051: | page_header = element page_header { |

| | |
|---|---|
| 052: | attribute page_number { text }, |
| 053: | text } |

054:

| | |
|---|---|
| 055: | clause = |
| 056: | element clause { |

| | |
|---|---|
| 057: | attribute n {text}? & |
| 058: | attribute type { text } & |

| | |
|---|---|
| 059: | element meta { |

| | |
|---|---|
| 060: | element keyvalue { |

| | |
|---|---|
| 061: | element key { text }, |
| 062: | element value { text } |

| | |
|---|---|
| 063: | }+ |

| | |
|---|---|
| 064: | } & |

| | |
|---|---|
| 065: | heading & |
| 066: | body & |
| 067: | page_break* & |

| | |
|---|---|
| 068: | page_header* & |
| 069: | page_footer* |
| 070: | } |

071:

| | |
|---|---|
| 072: | heading = element heading { |

| | |
|---|---|
| 073: | attribute inline { “true” \| “false” }, |
| 074: | element punc { text }?, |
| 075: | element label { text }?, |
| 076: | element punc { text }?, |
| 077: | element number { text }?, |
| 078: | element punc { text }?, |
| 079: | element title { text }?, |
| 080: | element punc { text }? |
| 081: | } |

082:

| | |
|---|---|
| 083: | text_segment = |

| | |
|---|---|
| 084: | element text_segment { |
| 085: | (element error { |

| | |
|---|---|
| 086: | element original { text }, |
| 087: | element corrected { text } |
| 088: | }* \| |
| 089: | text)* }* |

090:

| | |
|---|---|
| 091: | table = |

| | |
|---|---|
| 092: | element table { |

| | |
|---|---|
| 093: | element tr { |

| | |
|---|---|
| 094: | element th { text }* \| element td { text }* |

| | |
|---|---|
| 095: | }+ |

| | |
|---|---|
| 096: | } |

097:

| | |
|---|---|
| 098: | body = |
| 099: | element body { |

| | |
|---|---|
| 100: | clause* & |
| 101: | table* & |
| 102: | text_segment* & |
| 103: | page_footer* & |
| 104: | page_header* & |
| 105: | page_break* |

| | |
|---|---|
| 106: | } |

In the above XML schema definition, what is referred to herein as a section is defined as a clause. As can be seen from the above XML schema definition, a section/clause can have a heading element to represent the heading of the section/clause. A section/clause can be nested within another selection/clause to represent a hierarchical relationship between the sections/clauses.

Returning a previous example discussed above, the snippet of unstructured text portion consisting of the three lines of text might be represented in structured text that confirms to the above-schema definition as follows:

***

| | |
|---|---|
| 01: | <clause n=“e” type=“”> |
| 02: | <meta> |

| | |
|---|---|
| 03: | <keyvalue> |

| | |
|---|---|
| 04: | <key> |
| 05: | </key> |
| 06: | <value> |
| 07: | </value> |

| | |
|---|---|
| 08: | </keyvalue> |

| | |
|---|---|
| 09: | </meta> |
| 10: | <heading inline=“true“> |

| | |
|---|---|
| 11: | <punc><![CDATA[(]]></punc> |
| 12: | <number><![CDATA[e]]></number> |
| 13: | <punc><![CDATA[) ]]></punc> |
| 14: | <title><![CDATA[Payment of Stamp |

Tax]]></title>

| | |
|---|---|
| 15: | <punc><![CDATA[. ]]></punc> |

| | |
|---|---|
| 16: | </heading> |
| 17: | <body> |

| | |
|---|---|
| 18: | <text_segment> |

| | |
|---|---|
| 19: | <![CDATA[Subject to Section 11, |

it will pay any Stamp Tax levied or imposed upon it or in
respect of its execution or performance of this Agreement by a
jurisdiction in which it is incorporated, organised, managed and
controlled, or considered to have its seat, or in which a branch
or office through which it is acting for the purpose of this
Agreement is located (“Stamp Tax Jurisdiction”) and will
indemnify the other party against any Stamp Tax levied or
imposed upon the other party or in respect of the other party's
execution or performance of this Agreement by any such Stamp Tax
Jurisdiction which is not also a Stamp Tax Jurisdiction with
respect to the other party.
20:
21:

| | | |
|---|---|---|
| 22: | ]]> | </text_segment> |

| | |
|---|---|
| 23: | </body> |

| | |
|---|---|
| 24: | </clause> |

| | |
|---|---|
| 25: | </body> |

| | |
|---|---|
| 26: | </clause> |
| 27: | <clause n=“5” type=“”> |

| | |
|---|---|
| 28: | <meta> |

| | |
|---|---|
| 29: | <keyvalue> |

| | |
|---|---|
| 30: | <key> |
| 31: | </key> |
| 32: | <value> |
| 33: | </value> |

| | |
|---|---|
| 34: | </keyvalue> |

| | |
|---|---|
| 36: | </meta> |
| 37: | <heading inline=“true”> |

| | |
|---|---|
| 38: | <number><![CDATA[5]]></number> |
| 39: | <punc><![CDATA[. ]]></punc> |
| 40: | <title><![CDATA[Events of Default and |

Termination Events]]></title>

| | |
|---|---|
| 41: | </heading> |
| 42: | <body> |

| | |
|---|---|
| 43: | <text_segment> |

| | |
|---|---|
| 44: | <![CDATA[ |

| | |
|---|---|
| 45: | ]]> |

| | |
|---|---|
| 46: | </text_segment> |

| | |
|---|---|
| 47: | <clause n=“a” type=“”> |

| | |
|---|---|
| 48: | <meta> |

| | |
|---|---|
| 49: | <keyvalue> |

| | |
|---|---|
| 50: | <key> |
| 51: | </key> |
| 52: | <value> |
| 53: | </value> |

| | |
|---|---|
| 54: | </keyvalue> |

| | |
|---|---|
| 55: | </meta> |
| 56: | <heading inline=“true”> |

| | |
|---|---|
| 57: | <punc><![CDATA[(]]></punc> |
| 58: | <number><![CDATA[a]]></number> |
| 59: | <punc><![CDATA[) ]]></punc> |
| 60: | <title><![CDATA[Events of |

Default]]></title>

| | |
|---|---|
| 61: | <punc><![CDATA[. ]]></punc> |

| | |
|---|---|
| 62: | </heading> |
| 63: | <body> |

| | |
|---|---|
| 64: | <text_segment> |

| | |
|---|---|
| 65: | <![CDATA[The occurrence at any |

time with respect to a party or, if applicable, any Credit
Support Provider of such party or any Specified Entity of such
party of any of the following events constitutes an event of
default (an “Event of Default”) with respect to such party: -
66:
67:

| | | |
|---|---|---|
| 68: | ]]> | </text_segment> |

***

In the above-example structured text, three sections are represented.

A first section has the heading “(e) Payment of Stamp Tax.”

A second section has the heading “5. Events of Default and Termination Events”

A third section has the heading “(a) Events of Default.”

The nesting of the beginning clause element at Line 47 above with the beginning clause element at Line 27 represents that the third section is a child section of the second section.

The nesting of the ending clause element at Line 24 above within the ending clause element at Line 27 represents that the first section is at the same hierarchical level as the third section and that the first section is a child section of another section (not shown) that is at the same hierarchical level as the second section.

### Computing System Implementation

A possible implementation of the present invention may encompass performance of a method by a computing system having one or more processors and storage media. The one or more processors and the storage media can be provided by one or more computer systems. The storage media of the computing system can store one or more computer programs. The one or more programs can include instructions configured to perform the method. The instructions may be executed by the one or more processors to perform the method.

A possible implementation of the present invention can encompass one or more non-transitory computer-readable media. The one or more non-transitory computer-readable media may store the one or more computer programs that include the instructions configured to perform the method.

A possible implementation of the present invention can encompass the computing system having the one or more processors and the storage media storing the one or more computer programs that include the instructions configured to perform the method.

A possible implementation of the present invention can encompass one or more virtual machines that operate on top of one or more computer systems and emulate virtual hardware. A virtual machine can be a Type-1 or Type-2 hypervisor, for example. Operating system virtualization using containers is also possible instead of, or in conjunction with, hardware virtualization using hypervisors.

For a possible implementation that encompasses multiple computer systems, the computer systems may be arranged in a distributed, parallel, clustered or other suitable multi-node computing configuration in which computer systems are continuously, periodically, or intermittently interconnected by one or more data communications networks (e.g., one or more internet protocol (IP) networks.) Further, it need not be the case that the set of computer systems that execute the instructions be the same set of computer systems that provide the storage media storing the one or more computer programs, and the sets may only partially overlap or may be mutually exclusive. For example, one set of computer systems may store the one or more computer programs from which another, different set of computer systems downloads the one or more computer programs and executes the instructions thereof.

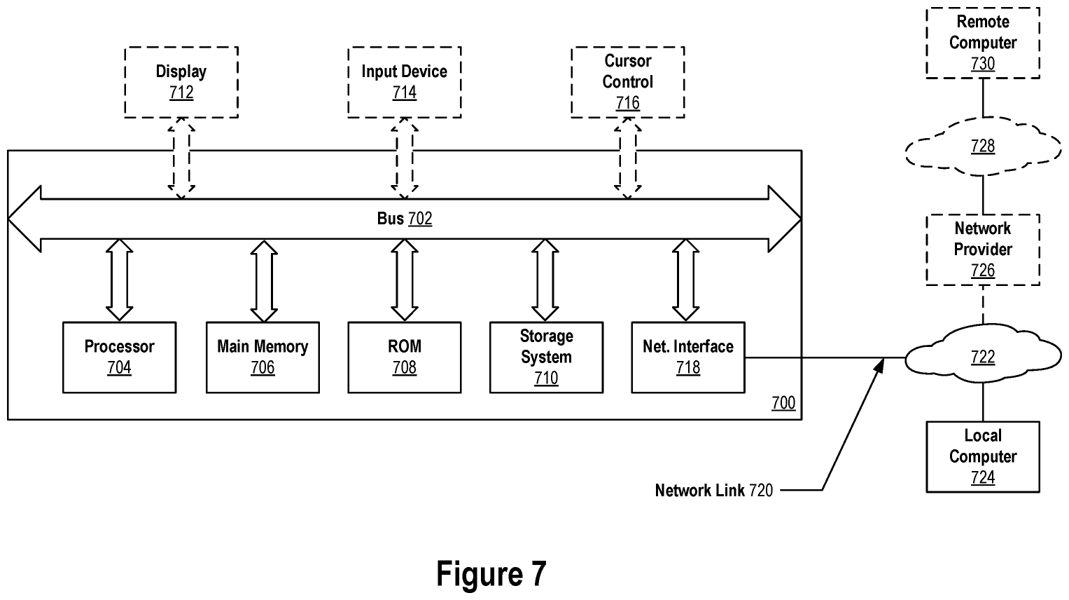

FIG. 7 is a block diagram of example computer system 700 used in a possible implementation of the present invention. Computer system 700 includes bus 702 or other communication mechanism for communicating information, and one or more hardware processors coupled with bus 702 for processing information.

Hardware processor 704 may be, for example, a general-purpose microprocessor, a central processing unit (CPU) or a core thereof, a graphics processing unit (GPU), or a system on a chip (SoC).

Computer system 700 also includes a main memory 706, typically implemented by one or more volatile memory devices, coupled to bus 702 for storing information and instructions to be executed by processor 704. Main memory 706 also may be used for storing temporary variables or other intermediate information during execution of instructions by processor 704.

Computer system 700 may also include read-only memory (ROM) 708 or other static storage device coupled to bus 702 for storing static information and instructions for processor 704.

A storage system 710, typically implemented by one or more non-volatile memory devices, is provided and coupled to bus 702 for storing information and instructions.

Computer system 700 may be coupled via bus 702 to display 712, such as a liquid crystal display (LCD), a light emitting diode (LED) display, or a cathode ray tube (CRT), for displaying information to a computer user. Display 712 may be combined with a touch sensitive surface to form a touch screen display. The touch sensitive surface may be an input device for communicating information including direction information and command selections to processor 704 and for controlling cursor movement on display 712 via touch input directed to the touch sensitive surface such by tactile or haptic contact with the touch sensitive surface by a user's finger, fingers, or hand or by a hand-held stylus or pen. The touch sensitive surface may be implemented using a variety of different touch detection and location technologies including, for example, resistive, capacitive, surface acoustical wave (SAW) or infrared technology.

Input device 714, including alphanumeric and other keys, may be coupled to bus 702 for communicating information and command selections to processor 704.

Another type of user input device may be cursor control 716, such as a mouse, a trackball, or cursor direction keys for communicating direction information and command selections to processor 704 and for controlling cursor movement on display 712. This input device typically has two degrees of freedom in two axes, a first axis (e.g., x) and a second axis (e.g., y), that allows the device to specify positions in a plane.

Instructions, when stored in non-transitory storage media accessible to processor 704, such as, for example, main memory 706 or storage system 710, render computer system 700 into a special-purpose machine that is customized to perform the operations specified in the instructions. Alternatively, customized hard-wired logic, one or more ASICs or FPGAs, firmware and/or hardware logic which in combination with the computer system causes or programs computer system 700 to be a special-purpose machine.

A computer-implemented process may be performed by computer system 700 in response to processor 704 executing one or more sequences of one or more instructions contained in main memory 706. Such instructions may be read into main memory 706 from another storage medium, such as storage system 710. Execution of the sequences of instructions contained in main memory 706 causes processor 704 to perform the process. Alternatively, hard-wired circuitry may be used in place of or in combination with software instructions to perform the process.

The term “storage media” as used herein refers to any non-transitory media that store data and/or instructions that cause a machine to operate in a specific fashion. Such storage media may comprise non-volatile media (e.g., storage system 710) and/or volatile media (e.g., main memory 706). Non-volatile media includes, for example, read-only memory (e.g., EEPROM), flash memory (e.g., solid-state drives), magnetic storage devices (e.g., hard disk drives), and optical discs (e.g., CD-ROM). Volatile media includes, for example, random-access memory devices, dynamic random-access memory devices (e.g., DRAM) and static random-access memory devices (e.g., SRAM).

Storage media is distinct from but may be used in conjunction with transmission media. Transmission media participates in transferring information between storage media. For example, transmission media includes coaxial cables, copper wire and fiber optics, including the circuitry that comprise bus 702. Transmission media can also take the form of acoustic or light waves, such as those generated during radio-wave and infra-red data communications.

Computer system 700 also includes a network interface 718 coupled to bus 702. Network interface 718 provides a two-way data communication coupling to a wired or wireless network link 720 that is connected to a local, cellular or mobile network 722. For example, communication interface 718 may be IEEE 702.3 wired “ethernet” card, an IEEE 702.11 wireless local area network (WLAN) card, an IEEE 702.15 wireless personal area network (e.g., Bluetooth) card or a cellular network (e.g., GSM, LTE, etc.) card to provide a data communication connection to a compatible wired or wireless network. In a possible implementation of the present invention, communication interface 718 sends and receives electrical, electromagnetic or optical signals that carry digital data streams representing various types of information.

Network link 720 typically provides data communication through one or more networks to other data devices. For example, network link 720 may provide a connection through network 722 to local computer system 724 that is also connected to network 722 or to data communication equipment operated by a network access provider 726 such as, for example, an internet service provider or a cellular network provider. Network access provider 726 in turn provides data communication connectivity to another data communications network 728 (e.g., the internet). Networks 722 and 728 both use electrical, electromagnetic or optical signals that carry digital data streams. The signals through the various networks and the signals on network link 720 and through communication interface 718, which carry the digital data to and from computer system 700, are example forms of transmission media.

Computer system 700 can send messages and receive data, including program code, through the networks 722 and 728, network link 720 and communication interface 718. In the internet example, a remote computer system 730 might transmit a requested code for an application program through network 728, network 722 and communication interface 718. The received code may be executed by processor 704 as it is received, and/or stored in storage device 710, or other non-volatile storage for later execution.

### CONCLUSION

In the foregoing detailed description, possible implementations of the present invention have been described with reference to numerous specific details that may vary from implementation to implementation. The detailed description and the figures are, accordingly, to be regarded in an illustrative rather than a restrictive sense.

Reference in the detailed description to a possible implementation of the present invention is not intended to mean that the implementation is exclusive of other implementations of the present invention, unless the context clearly indicates otherwise. Thus, an implementation or implementations of the present invention may be combined with one or more other implementations in an overall combination, unless the context clearly indicates that the implementations are incompatible. Further, a described implementation is intended to illustrate the present invention by an example and is not intended to limit the present invention to the described implementation.

In the foregoing detailed description and in the appended claims, although the terms first, second, etc. are, in some instances, used herein to describe various elements, these elements should not be limited by these terms. These terms are only used to distinguish one element from another. For example, a first user interface could be termed a second user interface, and, similarly, a second user interface could be termed a first user interface, without departing from the scope of the present invention. The first user interface and the second user interface are both user interfaces, but they are not the same user interface.

As used in the foregoing detailed description and in the appended claims, the singular forms “a,” “an,” and “the” are intended to include the plural forms as well, unless the context clearly indicates otherwise. As used in the foregoing detailed description and in the appended claims, the term “and/or” refers to and encompasses any and all possible combinations of one or more of the associated listed items.

As used in the foregoing detailed description in the appended claims, the terms “based on,” “according to,” “includes,” “including,” “comprises,” and/or “comprising,” specify the presence of stated features, integers, steps, operations, elements, and/or components, but do not preclude the presence or addition of one or more other features, integers, steps, operations, elements, components, and/or groups thereof.

For situations in which an implementation of the present invention collects information about users, the users may be provided with an opportunity to opt in/out of programs or features that may collect personal information. In addition, in a possible implementation of the present invention, certain data may be anonymized in one or more ways before it is stored or used, so that personally identifiable information is removed. For example, a user's identity may be anonymized so that the personally identifiable information cannot be determined for or associated with the user, and so that user preferences or user interactions are generalized rather than associated with a particular user. For example, the user preferences or user interactions may be generalized based on user demographics.

1. A computer-implemented method, comprising:
using a trained sequence labeling model to tag tokens in first text;
based on tags assigned to tokens in the first text by the trained sequence labeling model, identifying section boundaries in the first text;
based on the section boundaries identified in the first text, identifying sections in the first text; and
storing second text comprising and identifying the sections.

2. The computer-implemented method of claim 1, further comprising:
based on styles of text, of the first text, that start the sections identified in the first text, identifying hierarchical relationships between the sections; and
storing the second text identifying the hierarchical relationships between the sections.

3. The computer-implemented method of claim 1, further comprising:
determining a first style of a text, of the first text, that starts a first section of the sections;
determining if the first style is a new style or a previously detected style among one or more sections of the sections processed so far;
if the first style is the new style, then creating a new hierarchical level for the new style and assigning the first section to the new hierarchical level, or if the first style is the previously detected style, then assigning the first section to a hierarchical level previously created for the previously detected style.

4. The computer-implemented method of claim 1, further comprising:
reading a window of the first text;
adaptively tokenizing the window of the first text to obtain a set of tokens, wherein at least a first token of the set of tokens is a single-character token and at least a second token of the set of tokens is a multi-character token; and
using the trained sequence labeling model to tag the first token; and
using the training sequence labeling model to tag the second token.

5. The computer-implemented method of claim 1, further comprising:
reading a window of text from a training example;
adaptively tokenizing the window of text to obtain a set of tokens;
tagging a first token in the set of tokens as beginning a heading;
tagging a second token in the set of tokens as inside the heading; and
learning the trained sequence labeling model based on a tagged version of the training example in which the first token is tagged as beginning the heading and the second token is tagged as inside the heading.

6. The computer-implemented method of claim 1, further comprising:
converting an IOB sequence to a labeled training item sequence; and
learning the trained sequence labeling model based on the labeled training item sequence.

7. The computer-implemented method of claim 1, further comprising:
generating local heading features for an IOB of an IOB sequence;
generating heading context features for the JOB;
generating a labeled training item sequence for the IOB sequence based on the local heading features and the heading context features generated for the JOB; and
learning the trained sequence labeling model based on the labeled training item sequence.

8. The computer-implemented method of claim 1, wherein:
the first text is unstructured text; and
the second text is structured text.

9. One or more non-transitory storage media storing one or more computer programs comprising:
instructions which, when executed by a computing system having one or more processors, cause the computing system to perform:
using a trained sequence labeling model to tag tokens in unstructured text;
based on tags assigned to tokens in the unstructured text by the trained sequence labeling model, identifying section boundaries in the unstructured text;
based on the section boundaries identified in the unstructured text, identifying sections in the unstructured text; and
storing structured text comprising and identifying the sections.

10. The one or more non-transitory storage media of claim 9, wherein the one or more computer programs further comprise:
instructions which, when executed by the computing system, cause the computing system to perform:
based on styles of text, of the unstructured text, that start the sections identified in the unstructured text, identifying hierarchical relationships between the sections; and
storing the structured text identifying the hierarchical relationships between the sections.

11. The one or more non-transitory storage media of claim 9, wherein the one or more computer programs further comprise:
instructions which, when executed by the computing system, cause the computing system to perform:
determining a first style of a text, of the unstructured text, that starts a first section of the sections;
determining if the first style is a new style or a previously detected style among one or more sections of the sections processed so far;
if the first style is the new style, then creating a new hierarchical level for the new style and assigning the first section to the new hierarchical level, or
if the first style is the previously detected style, then assigning the first section to a hierarchical level previously created for the previously detected style.

12. The one or more non-transitory storage media of claim 9, wherein the one or more computer programs further comprise:
instructions which, when executed by the computing system, cause the computing system to perform:
reading a window of the unstructured text;
adaptively tokenizing the window of the unstructured text to obtain a set of tokens, wherein at least a first token of the set of tokens is a single-character token and at least a second token of the set of tokens is a multi-character token; and
using the trained sequence labeling model to tag the first token; and
using the training sequence labeling model to tag the second token.

13. The one or more non-transitory storage media of claim 9, wherein the one or more computer programs further comprise:
instructions which, when executed by the computing system, cause the computing system to perform:
reading a window of text from a training example;
adaptively tokenizing the window of text to obtain a set of tokens;
tagging a first token in the set of tokens as beginning a heading;
tagging a second token in the set of tokens as inside the heading; and
learning the trained sequence labeling model based on a tagged version of the training example in which the first token is tagged as beginning the heading and the second token is tagged as inside the heading.

14. The one or more non-transitory storage media of claim 9, wherein the one or more computer programs further comprise:
instructions which, when executed by the computing system, cause the computing system to perform:
converting an IOB sequence to a labeled training item sequence; and
learning the trained sequence labeling model based on the labeled training item sequence.

15. The one or more non-transitory storage media of claim 9, wherein the one or more computer programs further comprise:
instructions which, when executed by the computing system, cause the computing system to perform:
generating local heading features for an IOB of an IOB sequence;
generating heading context features for the JOB;
generating a labeled training item sequence for the JOB sequence based on the local heading features and the heading context features generated for the JOB; and
learning the trained sequence labeling model based on the labeled training item sequence.

16. A computing system comprising:
one or more processors;
storage media; and
instructions stored in the storage media and which, when executed by the computing system, cause the computing system to perform:
using a trained sequence labeling model to tag tokens in unstructured text;
based on tags assigned to tokens in the unstructured text by the trained sequence labeling model, identifying clause boundaries in the unstructured text;
based on the clause boundaries identified in the unstructured text, identifying clauses in the unstructured text; and
storing structured text comprising and identifying the clauses.

17. The computing system of claim 16, further comprising:
instructions stored in the storage media and which, when executed by the computing system, cause the computing system to perform:
based on styles of text, of the unstructured text, that start the clauses identified in the unstructured text, identifying hierarchical relationships between the clauses; and
storing the structured text identifying the hierarchical relationships between the clauses.

18. The computing system of claim 16, further comprising:
instructions stored in the storage media and which, when executed by the computing system, cause the computing system to perform:
determining a first style of a text, of the unstructured text, that starts a first section of the clauses;
determining if the first style is a new style or a previously detected style among one or more sections of the sections processed so far;
if the first style is the new style, then creating a new hierarchical level for the new style and assigning the first section to the new hierarchical level, or
if the first style is the previously detected style, then assigning the first section to a hierarchical level previously created for the previously detected style.

19. The computing system of claim 16, further comprising:
instructions stored in the storage media and which, when executed by the computing system, cause the computing system to perform:
reading a window of the unstructured text;
adaptively tokenizing the window of the unstructured text to obtain a set of tokens, wherein at least a first token of the set of tokens is a single-character token and at least a second token of the set of tokens is a multi-character token; and
using the trained sequence labeling model to tag the first token; and
using the training sequence labeling model to tag the second token.

20. The computing system of claim 16, further comprising:
instructions stored in the storage media and which, when executed by the computing system, cause the computing system to perform:
reading a window of text from a training example;
adaptively tokenizing the window of text to obtain a set of tokens;
tagging a first token in the set of tokens as beginning a heading;
tagging a second token in the set of tokens as inside the heading; and
learning the trained sequence labeling model based on a tagged version of the training example in which the first token is tagged as beginning the heading and the second token is tagged as inside the heading.
